(19) United States
(12) Patent Application Publication
(10) Pub. No.: US 2024/0113477 A1
(43) Pub. Date: Apr. 4, 2024

(54) CONNECTOR

(71) Applicant: MOLEX, LLC, Lisle, IL (US)

(72) Inventors: Makoto Shinyama, Yamato (JP); Nobuyuki Kondo, Yamato (JP)

(21) Appl. No.: 18/285,497

(22) PCT Filed: Mar. 8, 2022
(86) PCT No.: PCT/IB2022/052019

§ 371 Date: Oct. 4, 2023

(30) Foreign Application Priority Data
May 7, 2021 (JP) 2021-078898

(51) Int. Cl. H01R 13/6585; H01R 13/6594

(52) U.S. Cl. CPC H01R 13/6585; H01R 13/6594

(57) ABSTRACT

A first connector body and a first terminal mounted to said first connector body; the first connector body having a first recessed part, a first side wall part that extends in the longitudinal direction and demarcates both sides of the first recessed part, an islet extending in the longitudinal direction inside the first recessed part, and a first recessed groove part formed between the islet and the first side wall part; a plurality of the first terminals are arranged along each of the first recessed groove parts and form a pair of terminal group rows in parallel, where each terminal group row includes at least a part of a first ground member, and the first ground member is exposed on the mounting surface of the first connector body and connected to reference potential wiring by soldering to the center in the width direction and the outer part in the width direction of the first connector body.

### RELATED APPLICATIONS

This application claims priority to Japanese Patent Application No. 2021-078898 filed on May 7, 2021, which is incorporated herein by reference in its entirety.

### TECHNICAL FIELD

The present disclosure relates to a connector.

### BACKGROUND ART

Conventionally, connectors such as substrate-to-substrate connectors have been used to electrically connect pairs of parallel circuit boards to each other. Such connectors are attached to each of opposing surfaces of the pair of circuit boards, and fitted together to secure electric conduction. Furthermore, in order to prevent crosstalk between signal terminals, technology has been proposed in which a ground connection fitting is provided between the signal terminals (for example, see Patent Document 1).

FIG. 29 is an exploded perspective view illustrating a conventional board to board connector prior to mating.

In the drawings, 811 is a receptacle housing of the receptacle connector 810 as a connector mounted on a surface of the circuit board P, and 851 is a receptacle reinforcement fitting attached to both ends of the receptacle housing 811 in the longitudinal direction, and is connected by soldering or the like to a connection pad coupled to the ground trace of the circuit board P.

A plurality of receptacle signal terminals 861 are mounted forming a row on both left and right sides of the receptacle housing 811. Each of the receptacle signal terminals 861 are connected using soldering or the like to a connection pad connected to a signal trace of the circuit board P. Note that the outer side of the sidewall part on both the left and right sides of the receptacle housing 811 is covered by a connecting plate 852 that mutually connects receptacle reinforcement fittings 851 mounted to both ends in the longitudinal direction.

In addition, an elongated plate shaped ground connection fitting 856 extending in the longitudinal direction of the receptacle housing 811 is arranged between the rows of receptacle signal terminals 861 aligned on both the left and right sides. The ground connection fitting 856 is connected to a connection pad connected to the ground trace of the circuit board P by soldering or the like, and is also mechanically and electrically connected to the receptacle reinforcement fitting 851.

On the other hand, in the figure, 911 is a plug housing of a plug connector 910 as a connector mounted on the surface of a second circuit board (not shown), and 951 is a plug reinforcement fitting attached to both ends of the plug housing 911 in the longitudinal direction and is connected to the connection pad connected to the ground trace of the second circuit board by soldering or the like.

Further, a plurality of plug signal terminals 961 are mounted in a row on each of the side walls on both left and right sides of the plug housing 911, and each of the plug signal terminals 961 is connected to the connection pad coupled to a signal trace on the second circuit board by soldering or the like.

Furthermore, the plug connector 910 is displaced in the drawings to show the arrow Q and is mated with the receptacle connector 810. In a state where the receptacle connector 810 and the plug connector 910 are mated, the receptacle housing 811 and the plug housing 911 are mated to each other, and the mutually corresponding receptacle signal terminals 861 and the plug signal terminals 961 are in contact with each other and conduct. The receptacle reinforcement fitting 851 and the plug reinforcement fitting 951 are in contact and conduct, and further, the ground connection fitting 856 and the plug reinforcement fitting 951 are in contact and conduct. As a result, the receptacle signal terminals 861 and the plug signal terminals 961 on both sides facing each other are shielded by the plate type ground connection fitting 856 and in cases where signals are transferred between the mutually corresponding receptacle signal terminals 861 and plug signal terminals 961, crosstalk is prevented between the receptacle signal terminals 861 and plug signal terminals 961.

Prior Art Documents: Patent Documents: Patent Document 1: Japanese Unexamined Patent Application 2020-021697

### SUMMARY

However, in a conventional connector, since the ground connection fittings 856 are only arranged between the rows on the left and right sides of the receptacle signal terminals 861 and plug signal terminals 961, preventing crosstalk between receptacle signal terminals 861 and plug signal terminals 961 that are in the same row is difficult.

Here, an object of the present disclosure is to solve the problems of the known connector, and to provide a highly reliable connector that has a high shielding effect and reliably reduces crosstalk.

For resolution, the present disclosure is a first connector containing:
a first connector body, and
a first terminal mounted to the first connector body, wherein
the first connector body includes:
a first recessed part,
a first side wall part extending in the longitudinal direction that demarcates both sides of the first recessed part,
an islet extending in the longitudinal direction inside the first recessed part, and
a first recessed groove part formed between this islet and the first side wall part,
a plurality of the first terminals are arranged along each first recessed groove part forming a pair of parallel terminal group rows,
each of the terminal group rows includes at least a part of a first ground member, and
the first ground member is exposed on the mounting surface of the first connector body and connected by solder to reference potential wiring positioned to the center as well as outside in the width direction of the first connector body.

With another first connector, a portion of the first ground member included in each of the terminal group rows is a first ground terminal, and the first ground terminals included in each of the terminal group rows are arranged in a position facing each other and are connected via the first ground connecting part.

Regarding yet another first connector, the first connector further has a shield member that continuously surrounds the first connector body in plan view, and said shield member is connected to reference potential wiring by soldering in a plurality of locations on the exterior of the first connector body.

A connector pair consists of the first connector and a counterpart connector that mates with the first connector.

A second connector includes:
a second connector body, and
a second terminal mounted to the second connector body,
the second connector body includes a second recessed groove part and a pair of second side wall parts extending in a longitudinal direction of the second connector body,
arranged in parallel demarcating both sides of the second recessed groove part, wherein
a plurality of the second terminals are arranged along each second side wall parts forming a pair of parallel terminal group rows,
each terminal group row includes at least a part of a second ground member, and
the second ground member is exposed on the mounting surface of the second connector body and is connected by solder to reference potential wiring positioned to the center as well as to the outside of the second connector body.

With another second connector, a portion of the second ground member included in each of the terminal group rows is a second ground terminal, and the second ground terminals included in each of the terminal group rows are arranged in a position facing each other and connected via the second ground connecting part.

Regarding yet another second connector, the second connector body includes a second mating guide part formed at both ends in the longitudinal direction thereof and a second reinforcement fitting connected to the second ground member is mounted to this second mating guide part.

A connector pair consists of the second connector and a counterpart connector that mates with the second connector.

The connector according to the present disclosure has a high shielding effect and reliably reduces crosstalk to improve reliability.

### BRIEF DESCRIPTION OF THE DRAWINGS

FIG. 1 is a perspective view prior to mating of the first connector to the second connector according to embodiment 1, where (a) is a perspective view as viewed from the mating surface of the first connector and (b) is a perspective view as viewed from the mounting surface of the first connector.

FIG. 2 is a perspective view of the first connector according to embodiment 1.

FIG. 3 is a four-plane diagram of the first connector according to embodiment 1, where (a) is a plan view, (b) is a side view, (c) is a bottom view, and (d) is a front view.

FIG. 4 is an exploded view illustrating the first connector of embodiment 1.

FIG. 5 is a cross-sectional view of the first connector according to embodiment 1, where (a) is a plan view, (b) is a sectional view taken along the A-A line in (a), and (c) is a sectional view taken along the B-B line in (a).

FIG. 6 is a bottom view illustrating the first connector solder locations according to embodiment 1.

FIG. 7 is a perspective view of the second connector according to embodiment 1.

FIG. 8 is a four-plane diagram of a second connector according to embodiment 1, where (a) is a plan view, (b) is a side view, (c) is a bottom view, and (d) is a front view.

FIG. 9 is an exploded view illustrating the second connector according to embodiment 1.

FIG. 10 is a cross-sectional view of the second connector according to embodiment 1, where (a) is a plan view, (b) is a sectional view taken along the C-C line in (a), and (c) is a sectional view taken along the D-D line in (a).

FIG. 11 is a bottom view illustrating the second connector solder locations according to embodiment 1.

FIG. 12 is a plan view and cross-sectional view of the first connector and second connector of embodiment 1 in a mated state, where (a) is a plan view, and (b) is a sectional view taken along the E-E line in (a).

FIG. 13 is a cross-sectional view with the first connector and second connector of embodiment 1 mated where (a) is a sectional view taken along the F-F line in FIGS. 12(a) and (b) is a sectional view taken along the G-G line in FIG. 12(a).

FIG. 14 is a plan view of the first connector and second connector of embodiment 1 mated with the first housing and second housing omitted.

FIG. 15 is a perspective view prior to mating of the first connector to the second connector according to embodiment 2, where (a) is a perspective view as viewed from the mating surface of the first connector and (b) is a perspective view as viewed from the mounting surface of the first connector.

FIG. 16 is a perspective view of the first connector according to embodiment 2.

FIG. 17 is a four-plane diagram of a first connector according to embodiment 2, where (a) is a plan view, (b) is a side view, (c) is a bottom view, and (d) is a front view.

FIG. 18 is an exploded view illustrating the first connector according to embodiment 2.

FIG. 19 is a plan view and a cross-sectional view of the first connector according to embodiment 2, where (a) is a plan view, (b) is a sectional view taken along the H-H line in (a), and (c) is a sectional view taken along the I-I line in (a).

FIG. 20 is a bottom view illustrating the first connector solder locations according to embodiment 2.

FIG. 21 is a perspective view of the second connector according to embodiment 2.

FIG. 22 is a four-plane diagram of a second connector according to embodiment 2, where (a) is a plan view, (b) is a side view, (c) is a bottom view, and (d) is a front view.

FIG. 23 is an exploded view illustrating the second connector according to embodiment 2.

FIG. 24 is a plan view and a cross-sectional view of the second connector according to embodiment 2, where (a) is a plan view, (b) is a sectional view taken along the J-J line in (a), and (c) is a sectional view taken along the K-K line in (a).

FIG. 25 is a bottom view illustrating the second connector solder locations according to embodiment 2.

FIG. 26 is a plan view and cross-sectional view of the first connector and second connector of embodiment 2 in a mated state, where (a) is a plan view, and (b) is a sectional view taken along the L-L line in (a).

FIG. 27 is a cross-sectional view with the first connector and second connector of embodiment 2 in a mated state where (a) is a sectional view taken along the M-M line in FIGS. 26(a) and (b) is a sectional view taken along the N-N line in FIG. 26(a).

FIG. 28 is a plan view of the first connector and second connector of embodiment 2 in a mated state with the first housing and second housing omitted.

FIG. 29 is an exploded perspective view illustrating a conventional board to board connector prior to mating.

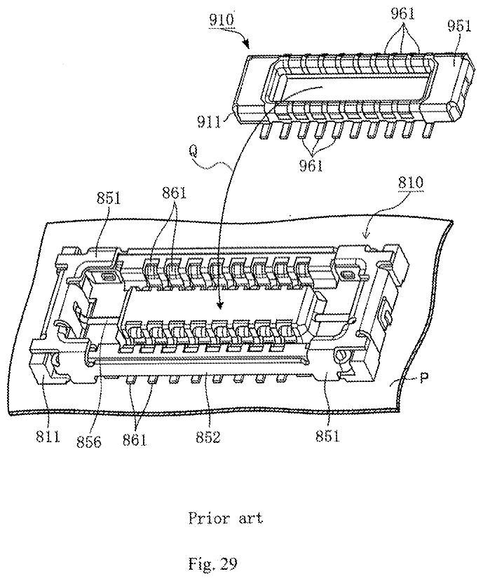

### DETAILED DESCRIPTION OF THE PREFERRED EMBODIMENTS

Embodiments will hereinafter be described in detail with reference to the drawings.

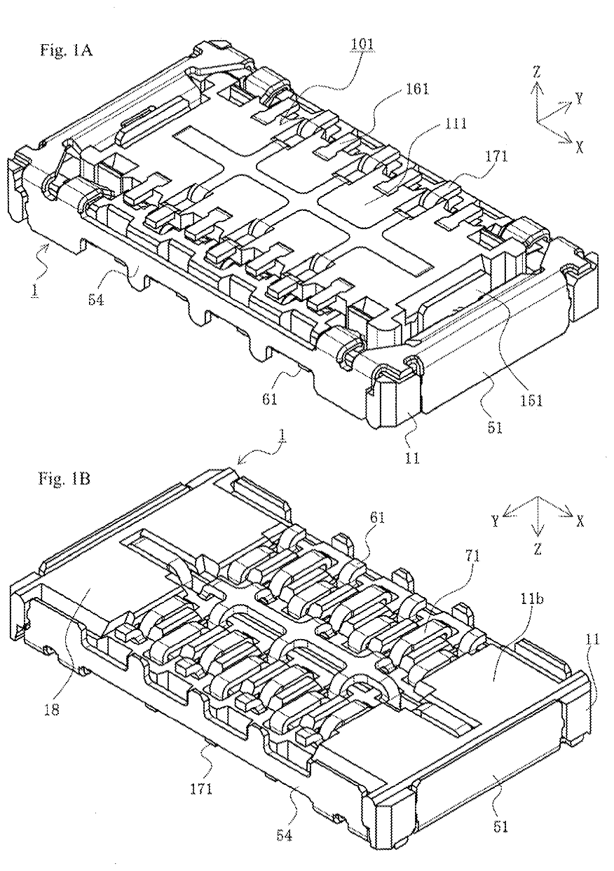

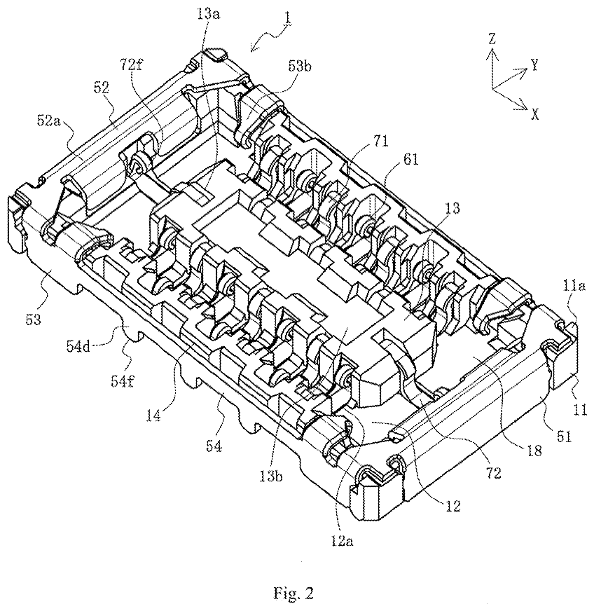

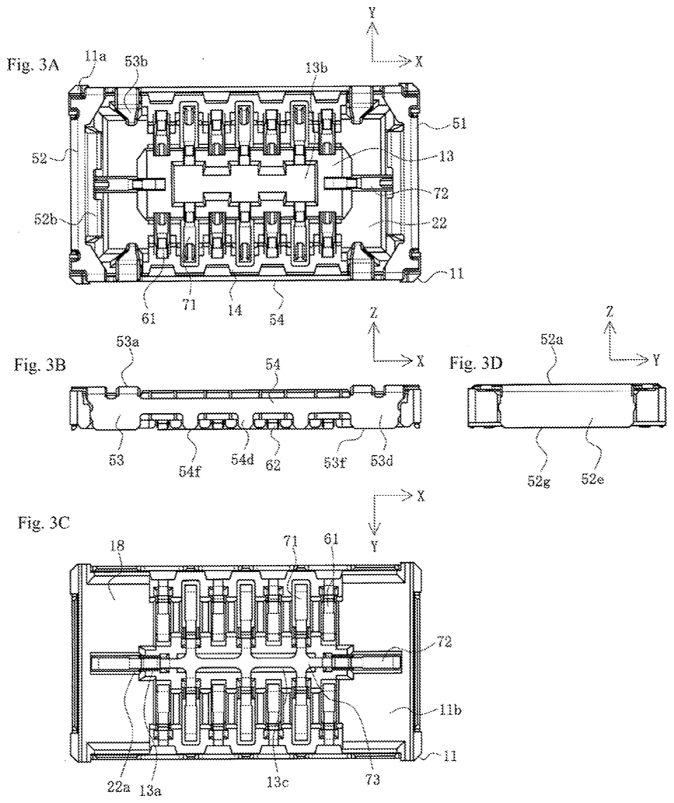

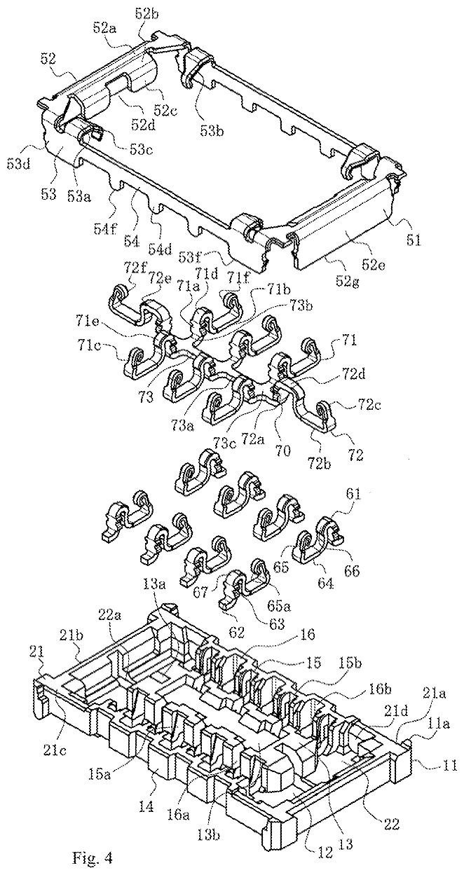

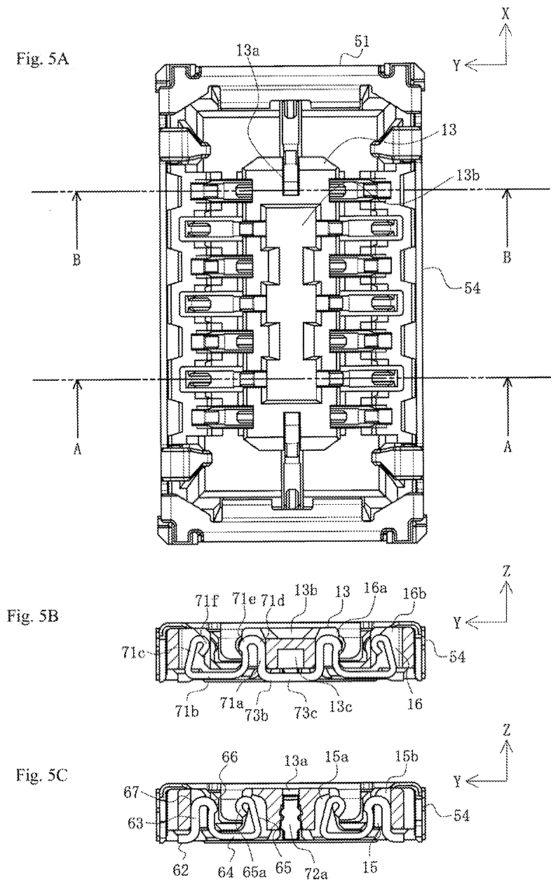

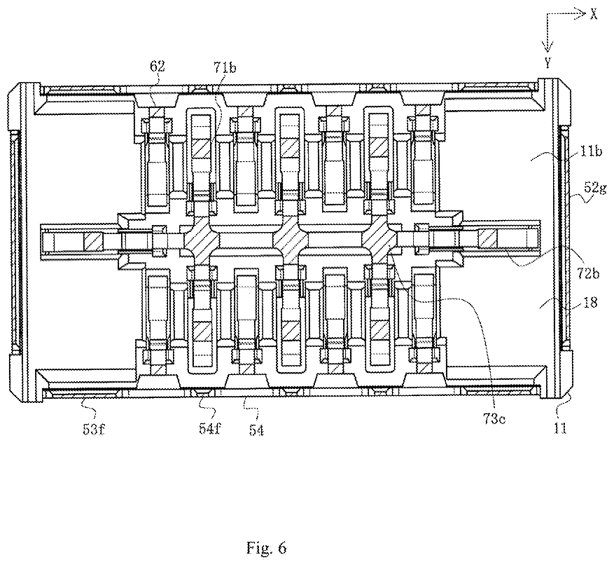

FIG. 1 is a perspective view of mating a first connector and a second connector according to embodiment 1. FIG. 2 is a perspective view of the first connector according to embodiment 1. FIG. 3 is a four-plane diagram of the first connector according to embodiment 1. FIG. 4 is an exploded view of the first connector according to embodiment 1. FIG. 5 is a plan view and cross-sectional view of the first connector according to embodiment 1. FIG. 6 is a bottom view of the solder locations of the first connector according to embodiment 1. Note that, in FIG. 1, (a) is a perspective view of the first connector as viewed from the mating surface, (b) is a perspective view of the first connector as viewed from the mounting surface. In FIG. 3, (a) is a plan view, (b) is a side view, (c) is a bottom view, and (d) is a front view. In FIG. 5, (a) is a plan view, (b) is a sectional view taken along the line A-A in (a), and (c) is a sectional view taken along the line B-B in (a).

In the figures, 101 is a connector according to the present embodiment, which is a second connector in one of a pair of connectors that is a connector assembly. The second connector 101 is a surface mounted connector (or a so-called plug connector) mounted on the surface of a second board that is a mounting member (not shown), and is mated with a first connector 1 that is a counterpart connector. The counterpart connector for the second connector 101 is not necessarily limited to the first connector 1, and may be any kind of connector as long as it can be mated with the second connector 101 to form a connector assembly or connector pair. However, for the sake of explanation, it is assumed that the first connector 1 is used as the counterpart connector.

The first connector 1 is also a connector in the present embodiment, and is the other of a pair of connectors. The first connector 1 is a surface mounted connector (or a so-called receptacle connector) mounted on the surface of a first board (not shown), and is mated with a second connector 101 that is a counterpart connector. The counterpart connector for the first connector 1 is not necessarily limited to the second connector 101, and may be any kind of connector as long as it can be mated with the first connector 1 and form a connector assembly or connector pair. However, for the sake of explanation, it is assumed that the second connector 101 is used as the counterpart connector.

The first connector 1 and the second connector 101 according to the present embodiment are preferably used to electrically connect the first substrate to the second substrate, but can also be used to electrically connect other members. For example, the first substrate and the second substrate are each a printed circuit board, a flexible flat cable (FFC), a flexible circuit board (FPC) or the like as used in electronic devices or the like, but may be any type of substrate.

In addition, in the present embodiment, expressions indicating direction such as top, bottom, left, right, front, rear, and the like used to describe the configuration and operation of each part of the first connector 1 and the second connector 101 are relative rather than absolute and are appropriate when each part of the first connector 1 and the second connector 101 are in the positions illustrated in the drawings; that said, these directions should be interpreted as changing in accordance with the change in position when the position thereof is changed.

The first connector 1 has a first housing 11 that is a first connector body which is a counterpart connector body integrally formed of an insulating material such as synthetic resin. As illustrated in the drawing, the first housing 11 is a substantially rectangular body having a substantially rectangular thick plate shape, wherein a first recessed part 12 is a recessed part serving as a substantially rectangular recessed part surrounding the periphery and mating with a second housing 111 as the second connector body of the second connector 101 is formed on the side in which the second connector 101 mates, that is, on the mating surface 11a side (the Z axis positive direction side). Furthermore, a first protrusion 13 that is an islet to be mated with a second recessed groove part 113 formed on a mating surface 111a described below of the second connector 101 is formed in the first recessed part 12 to be integral with the first housing 11.

Further, first side wall parts 14 that are counterpart side walls extending parallel to a first protrusion 13 and defining both sides of the first recessed part 12 are formed on both sides (the positive and negative Y-axis directions) of the first protrusion 13 integrally with the first housing 11. The first protrusion 13 and the first side wall parts 14 protrude upward (Z-axis negative direction) from a bottom plate 18 defining a bottom surface of the first recessed part 12, and extend in the longitudinal direction of the first housing 11. Consequently, as a part of the first recessed part 12, first recessed groove parts 12a that are elongated recesses extending in the longitudinal direction of the first housing 11 are formed on both sides of the first protrusion 13.

Furthermore, a first protruding end part 21 as a first mating guide part that is a counterpart mating guide part is arranged on each of both longitudinal ends of the first housing 11. The fitting recess 22 is formed as part of the first recessed part 12 in each first protrusion end 21. The mating recess 22 is a substantially rectangular recess, and is connected to both ends in the longitudinal direction of each first recessed groove part 12a. With the first connector 1 and second connector 101 mated, a second protruding end part 122 (described below) and second side wall part 112 of the second housing 111 of the second connector 101 are inserted into the mating recess 22 and into the first recessed groove part 12a.

First signal terminal housing cavities 15 are formed from both side surfaces of the first protrusion 13 to bottom surfaces of the first recessed groove parts 12a. In the illustrated example, the first signal terminal housing cavities 15 pass through the bottom plate 18 in the plate-thickness direction (Z-axis direction). Note that, out of the first signal terminal housing cavities 15, recessed grooves formed on both side surfaces of the first protrusion 13 are referred to as first signal terminal housing inner cavity 15a, and recessed grooves formed on side surfaces of the first side wall parts 14, which are opposed to the first protrusion 13, are referred to as the first signal terminal housing outer cavity 15b.

In addition, first ground terminal housing cavities 16 are formed between the first signal terminal housing cavities 15, adjacent to each other, from both side surfaces of the first protrusion 13 to the bottom surface of the first recessed groove part 12a. In the illustrated example, the first ground terminal housing cavities 16 pass through the bottom plate 18 in the plate-thickness direction. Note that, out of the first ground terminal housing cavities 16, recessed grooves formed on both side surfaces of the first protrusion 13 are referred to as first ground terminal housing inner cavities 16a, and recessed grooves formed on side surfaces of the first side wall parts 14, which are opposed to the first protrusion 13, are referred to as first ground terminal housing outer cavities 16b.

In the present embodiment, when the first signal terminal housing cavities 15 and first ground terminal housing cavities 16 are described in an integrated manner, they are described as the first terminal housing cavities. A plurality of the first terminal housing cavities are each formed at a prescribed pitch on both sides of each first protrusion 13 so as to form two rows in the longitudinal direction of the first housing 11. In the illustrated example, the first signal terminal housing cavities 15 and first ground terminal housing cavities 16 are arranged so as to alternate in each row, formed with four first signal terminal housing cavities 15 and three first ground terminal housing cavities 16. Note that the pitch and number of the first signal terminal housing cavities 15 and first ground terminal housing cavities 16 can be changed as needed. A first signal terminal 61 as the counterpart signal terminal and a first ground terminal 71 as the counterpart ground terminal, both equipped in the first housing 11 and housed in each of the first signal terminal housing cavities 15 and first ground terminal housing cavities 16, are arranged with the same pitch and number of each on both sides of the first protrusion 13. In the present embodiment, if the first signal terminal 61 and first ground terminal 71 are described in an integrated manner, they are described as first terminals. A plurality of the first terminals are arranged along each first recessed groove part 12a and form a parallel pair of terminal group rows (mating terminal group rows).

Each of the first signal terminals 61 are individual members integrally formed by performing processing such as punching and bending on a conductive metal plate, and includes a held part 63, a tail part 62 as a board connecting part connected to the lower end of the held part 63, an upper connecting part 67 connected to the upper end of the held part 63, an outer contact part 66 connected to the lower end of the upper connecting part 67 and opposed to the held part 63, a lower connecting part 64 connected to the lower end of the outer contact part 66, and an inner connecting part 65 connected to an end of the lower connecting part 64 on the opposite side to the outer contact part 66.

The held part 63 is a portion that is mated in and held by the first signal terminal housing outer cavity 15b while extending in the vertical direction (Z-axis direction), namely, in the thickness direction of the first housing 11. Note that the first signal terminal 61 is not necessarily attached to the first housing 11 by press fitting, but may be integrated with the first housing 11 by overmolding or insert molding. Here, for convenience of description, only the case in which the held part 63 is pressed into and held by the first signal terminal housing outer cavity 15b will be described.

The tail part 62 is bent and connected to the held part 63, extends in a left-right direction (Y-axis direction), namely, outward in the width direction of the first housing 11, and the bottom surface thereof (Z-axis negative direction side surface) is connected to the connection pad coupled to the conductive trace of the first substrate by soldering.

The upper connecting part 67 is a portion that is curved by about 180 degrees so as to protrude upward (Z-axis positive direction). The outer contact part 66 extending downward (Z-axis negative direction) is connected to the lower end of the upper connecting part 67 on the opposite side to the held part 63. A part of the outer contact part 66 desirably protrudes inward in the width direction of the first housing 11.

The lower connecting part 64 is a portion including a substantially U-shaped side surface connected to the lower end of the outer contact part 66. An inner contact part 65a curved by about 180 degrees is connected to the upper end of the inner connection part 65 so as to protrude upward and toward the outer contact part 66.

The first signal terminals 61 are pressed into the first signal terminal housing cavities 15 from the side of the mounting surface 11b that is a lower surface (a surface in the Z-axis negative direction) of the first housing 11, and the held part 63 is sandwiched from both sides by the side walls of the first signal terminal housing outer cavity 15b formed on the inner side surface of the first side wall part 14, whereby the first signal terminal 61 is fixed to the first housing 11. In this state, namely, in the state in which the first signal terminal 61 is loaded into the first housing 11, the inner contact part 65a and the outer contact part 66 are positioned on the right and left sides of the first recessed groove part 12a and face each other. In addition, when viewed from the longitudinal direction of the first housing 11, most of the held part 63 is housed in the first signal terminal housing outer cavity 15b, and most of the inner contact part 65a is housed in the first signal terminal housing inner cavity 15a. Furthermore, the lower surface of the tail part 62 is positioned below the mounting surface 11b (the lower surface of the bottom plate 18).

The first signal terminal 61 is a member integrally formed by processing such as punching or bending a metal plate, and thus has a certain degree of elasticity. As is clear from the shape, an interval between the inner contact part 65a and the outer contact part 66 facing each other can be elastically changed. That is, when the second signal terminal 161 included in the second connector 101 is inserted between the inner contact part 65a and the outer contact part 66, the interval between the inner contact part 65a and the outer contact part 66 is elastically elongated.

As illustrated in FIG. 4, the first ground terminal 71 is a portion of the first ground member 70 and they are connected to each other. The first ground member 70 consists of a plurality of first ground terminals 71, a pair of first ground end connecting parts 72 arranged near both ends in the longitudinal direction (X-axis direction) of the first housing 11, and first ground connecting parts 73 that connect the plurality of first ground end connecting parts 71 and the pair of first ground end connecting parts 72. Note that the first ground member 70 is a member integrally formed by carrying out processing such as punching and bending on a metal plate.

Here, each of the first ground terminals 71 has a held part 71a, an upper connecting part 71d connected to the upper end of the held part 71a, an inner contact part 71e connected to the lower end of the upper connecting part 71d and facing the held part 71a, a lower connecting part 71b connected to the lower end of the inner contact part 71e, and an outer connecting part 71c connected to the lower connecting part 71b on the end on the opposite side to the inner contact part 71e.

The held part 71a is a portion that is mated in and held by the first ground terminal housing inner cavities 16a while extending in the vertical direction (Z-axis direction), or in other words, in the thickness direction of the first housing 11. Note that the first ground terminal 71 is not necessarily attached to the first housing 11 by press fitting, but may be integrated with the first housing 11 by overmolding or insert molding. Here, for convenience of description, only the case in which the held part 71a is pressed into and held by the first ground terminal housing inner cavities 16a will be described.

The upper connecting part 71d is a portion that is curved by about 180 degrees so as to protrude upward (Z-axis positive direction). The inner contact part 71e extending downward (Z-axis negative direction) is connected to the lower end of the upper connecting part 71d on the opposite side to the held part 71a. A part of the inner contact part 71e desirably protrudes outward in the width direction of the first housing 11.

The lower connecting part 71b is a portion including a substantially U-shaped side surface connected to the lower end of the inner contact part 71e. An outer contact part 71f curved by about 180 degrees is connected to the upper end outer connecting part 71c so as to protrude upward and toward the inner contact part 71e.

The first ground terminal 71 is pressed in from the mounting surface 11b which is the bottom surface of the first housing 11 into the first ground terminal housing cavities 16, and the held part 71a is secured in the first housing 11 by being sandwiched from both side walls of the first ground terminal housing inner cavities 16a formed on both side surfaces of the first protrusion 13. As a result, not only the first ground terminal 71, but the entire first ground member 70 including the first ground connecting part 73 is secured to the first housing 11. Furthermore, in the state in which the first ground terminal 71 is equipped in the first housing 11, the inner contact part 71e and outer contact part 71f are positioned on the left and right sides of the first recessed groove part 12a and face each other. As is clear from the shape, an interval between the inner contact part 71e and the outer contact part 71f facing each other can be elastically changed. That is, when the second ground terminal 171 included in the second connector 101 is inserted between the inner contact part 71e and the outer contact part 71f, the interval between the inner contact part 71e and the outer contact part 71f is elastically elongated. In addition, when viewed from the longitudinal direction of the first housing 11, most of the held part 71a is housed in the first ground terminal housing inner cavities 16a, and most of the outer contact part 71f is housed in the first ground terminal housing outer cavity 16b.

Here, each of the first ground end connecting parts 72 includes a held part 72a, an upper connecting part 72d connected to the upper end of the held part 72a, an inner contact part 72e connected to the lower end of the upper connecting part 72d and facing the held part 72a, a lower connecting part 72b connected to the lower end of the inner contact part 72e, and an outer connecting part 72c connected to the lower connecting part 72b on the end on the opposite side to the inner contact part 72e.

The held part 72a extends in the vertical direction (Z-axis direction), or in other words, in the thickness direction of the first housing 11 of the first protrusion 13, and is a portion pressed into the first ground member housing recess 13a formed on each of both longitudinal ends of the first housing 11 and held. Note that the first ground end connecting part 72 is not necessarily attached to the first housing 11 by press fitting, but may be integrated with the first housing 11 by overmolding or insert molding. Here, for convenience of description, only the case in which the held part 72a is pressed into and held by the first ground member housing recess 13a will be described.

The upper connecting part 72d is a bent portion of which shape from the side appears to be an inverted U-shape projecting upward. The inner contact part 72e extending downward (Z-axis negative direction) is connected to the lower end of the upper connecting part 72d on the opposite side to the held part 72a. A part of the inner contact part 72e desirably protrudes outward in the longitudinal direction of the first housing 11.

The lower connecting part 72b is a portion including a substantially U-shaped side surface connected to the lower end of the inner contact part 72e. An outer contact part 72f curved by about 180 degrees is connected to the upper end of the outer connecting part 72c so as to protrude upward and toward the inner contact part 72e.

The first ground end connecting part 72 is inserted from the mounting surface 11b which is the bottom surface of the first housing 11 into the first ground member housing recess 13a formed in the first protrusion 13 and the first ground member housing recess 22a formed in the mating recess 22, and housed. Furthermore, as described above, the held part 72a is press-fitted into the first ground member housing recess 13a, and the held part 72a is secured to the first housing 11 by being sandwiched by both side walls of the first ground member housing recess 13a. As a result, not only the first ground end connecting part 72, but the entire first ground member 70 including the first ground connecting part 73 is secured to the first housing 11. Furthermore, in the state in which the first ground end connecting part 72 is equipped in the first housing 11, the inner contact part 72e and outer contact part 72f are positioned on the front and back sides of the mating recess 22 and face each other. A portion of the inner contact part 72e protrudes into the mating recess 22 from the longitudinal end wall of the first protrusion 13, and a portion of the outer contact part 72f protrudes into the mating recess 22 from the inner surface of the first end wall 21b of the first protruding end part 21. As is clear from the shape, an interval between the inner contact part 72e and the outer contact part 72f facing each other can be elastically changed. That is, when the second reinforcement fitting 151 included in the second connector 101 is inserted between the inner contact part 72e and the outer contact part 72f, the interval between the inner contact part 72e and the outer contact part 72f is elastically elongated.

The first ground connecting part 73 has a strip-shaped vertical shaft part 73a that extends linearly in the longitudinal direction of the first housing 11, and a plurality of pairs (in the example shown, three pairs) of horizontal shaft parts 73b that extend outward toward the width direction of the first housing 11 from both sides of the vertical shaft part 73a in a plurality of locations (in the example, three locations) along the longitudinal direction of the vertical shaft part 73a. The portion where the horizontal shaft part 73b extends from both sides of the vertical shaft part 73a is a vertical and horizontal intersecting part 73c which is a connecting part for the vertical shaft part 73a and horizontal shaft part 73b, and the vertical and horizontal intersecting part 73c in plan view (seen from the vertical direction) is a + shape formed out of two T shapes back to back.

Regarding the present embodiment, both ends in the longitudinal direction of the vertical shaft part 73a are bent toward the lower end of the held part 72a of the first ground end connecting part 72 and connected. In addition, the horizontal shaft part 73b extending in the left-right direction (Y-axis direction) has the tip thereof bent toward the lower end of the held part 71a of the first ground terminal 71 and connected. In this manner, all first ground terminals 71, first ground end connecting parts 72, and first ground connecting parts 73 of the first ground member 70 are mechanically and electrically connected.

Furthermore, the first ground member housing recess 13a is a slit-shaped recessed groove extending in the longitudinal direction and vertical direction formed in the center of the width direction (Y-axis direction) of the first protrusion 13 on both ends in the longitudinal direction of the first housing 11 regarding the first protrusion 13, opening on the bottom surface of the bottom plate 18, and the upper surface and longitudinal direction end wall surface of the first protrusion 13. The first ground member housing recess 13a is connected to a first ground member housing recess 22a formed in the mating recess 22. Note that on the upper surface of the first protrusion 13, an upper surface recessed part 13b is formed with a recess facing downward, in the area corresponding to the first ground terminal 71 in the longitudinal direction. On the side of the mounting surface 11b of the first protrusion 13, a lower surface recessed part 13c is formed with a recess facing downward, in the area corresponding to the upper surface recessed part 13b in the longitudinal direction. As illustrated in FIG. 3(c), when viewed from below, at or more than half of the lower surface recessed part 13c is covered by the first ground connecting part 73 positioned therebelow.

The first protrusion end 21 includes first side wall extensions 21c that are counterpart fitting guide side walls extending in the longitudinal direction of the first housing 11 from both longitudinal ends of the first side wall part 14, and a first end wall 21b extending in the width direction of the first housing 11, both ends of the first end wall 21b being connected to the first side wall extensions 21c. In each first protrusion end 21, the first end wall 21b and the first side wall extensions 21c connected to both ends of the first end wall 21b form a continuous and substantially U-shaped side wall and define three sides of the substantially rectangular fitting recess 22. A part of the first ground member housing recess 22a is formed on the inner surface side of the first end wall 21b.

A first reinforcement fitting 51 that is a counterpart reinforcement fitting is attached to the first housing 11. According to the present embodiment, the first reinforcement fitting 51 is a member integrally formed by punching, bending or other processing of a metal plate, provided with:
a pair of first end wall covers 52 positioned on both ends in the longitudinal direction (X-axis direction) of the first housing 11 which cover the outside of the first end wall 21b of the first protruding end part 21,
first side wall covers 53 connected to both left and right ends of each of the first end wall covers 52 that cover the outside of the first sidewall extensions 21c, and first side plates 54 as first connecting parts extending in the longitudinal direction of the first housing 11 that act as a pair of connecting parts connecting the first side wall covers 53 to each other. The first reinforcement fitting 51, in plan view (viewed from the vertical direction), functions as a shield member that continuously surrounds the first housing 11.

The first end wall cover 52 includes an upper surface portion 52a that extends in a width direction of the first housing 11 and covers the greater part of an upper surface 21a of the first end wall 21b, an inclined inner cover portion 52b as a guiding portion extending obliquely downward from the inner edge of the first end wall 21b on the upper surface portion 52a, a vertical inner cover portion 52c that extends downward from a lower end of the inclined inner cover portion 52b, an outer cover portion 52e that extends downward from the outer edge of the first end wall 21b on the upper surface portion 52a, and connecting feet parts 52g at the lower end of the outer cover portion 52e. Note that a notch 52d is formed near the center in the width direction of the first housing 11 in the inclined inner cover portion 52b and vertical inner cover portion 52c.

The first side wall cover 53 includes an upper surface portion 53a that extends in the longitudinal direction of the first housing 11 and covers the upper surface of the first side wall extension 21c, an inclined elastic arm 53b that is a counterpart reinforcement fitting terminal extending diagonally downward from the inner edge of the first side wall extension 21c on the upper surface portion 53a, a contact protrusion 53c that bulges toward the center of the mating recess 22 in the vicinity of the lower end of the inclined elastic arm 53b, an outer cover portion 53d that extends downward from an outer edge of the first side wall extension 21c on the upper surface portion 53a, and connecting feet parts 53f at the lower end of the outer cover portion 53d.

The inclined inner cover portion 52b, the vertical inner cover portion 52c, the outer cover portion 52e, and the outer cover portion 53d and the like in the first reinforcement fitting 51 are inserted or press-fitted into the recess formed on the surface and the like of the first end wall 21b, from the side of the mating surface 11a which is the upper surface (surface in the Z-axis positive direction) of the first housing 11, and attached to the first housing 11. Note that the first reinforcement fitting 51 is not necessarily attached to the first housing 11 by insertion or press fit, and may be integrated with the first housing 11 by overmolding or insert molding. Here, for convenience of description, only the case in which the shield plate is attached to the first housing 11 by insertion or press fitting is described.

In a state where the first reinforcement fitting 51 is attached to the first housing 11, the bottom surface of the connecting feet parts 52g of the first end wall cover 52 are positioned lower than the mounting surface 11b (bottom surface of the bottom plate 18) and are substantially flush with the bottom surface of the tail part 62 of the first signal terminal 61. In addition, at least a part of the inclined elastic arm 53b of the first side wall cover 53 is housed in the inner recess 21d in a state separated from the bottom surface of the inner recess 21d of the first sidewall extension 21c, where a contact protrusion 53c is elastically displaceable in the direction of the first sidewall extension 21c and the bottom surface of connecting feet parts 53f are positioned lower than the mounting surface 11b and are substantially flush with the bottom surface of the tail part 62 of the first signal terminal 61. Note that in general, the term “flush” is used at construction sites, and means that two materials are finished so that they have the same surface, or that there is no step between the two surface and they are flat, etc. However, in this case, “flush” is used in the sense that the bottom surface of the connecting feet parts 52g and/or the bottom surface of the connecting feet parts 53f and bottom surface of the tail part 62 are not necessarily perfectly flat, but are positioned within a range of height on the connection pad of the first board where they can be soldered.

In addition, the first side plate 54 is an elongated flat strip-shaped plate extending in the thickness direction (Z-axis direction) and longitudinal direction of the first housing 11, each of both longitudinal ends of which are connected to the outer cover portion 53d of the first side wall cover 53. Furthermore, in the longitudinal direction of each first side plate 54, leg parts 54d extend downward from the position corresponding to each first ground terminal housing outer cavity 16b, and the lower end of the leg parts 54d become the connecting feet parts 54f. In a state where the first reinforcement fitting 51 is attached to the first housing 11, the first side plate 54 covers at least a portion of the outer surface of the first side wall part 14, and the bottom surface of the connecting feet parts 54f are positioned lower than the mounting surface 11b and are substantially flush with the bottom surface of the tail part 62 of the first signal terminal 61.

As described above, since a majority of the surface of the first protruding end part 21 is covered with the first reinforcement fitting 51, the strength of the first protruding end part 21 increases, and even when a force or impact is applied to the first protruding end part 21 in the operation of fitting the first connector 1 and the second connector 101 together, damage or deformation of the first protruding end part 21 can be reliably prevented. In addition, the first end wall cover 52 and first side wall cover 53 positioned on each of both longitudinal ends of the first housing 11 are connected by the first side plate 54, making the overall strength of the first reinforcement fitting 51 high, effectively reinforcing the first housing 11.

In FIG. 6, which is a bottom view of the first connector 1, parts of the first signal terminal 61, first ground member 70, and first reinforcement fitting 51 that are exposed on the mounting surface 11b and connected to the conductive trace of the first board via soldering to the soldering pad, or in other words, soldered parts, are indicated by shaded lines (hatching). For the first signal terminal 61, the only soldered part is the bottom surface of the tail part 62, and the connection pad to which the bottom surface of the tail part 62 is soldered to is connected to a conductive trace that transmits an electrical signal, or in other words, to a signal line. In addition, for the first ground member 70, the soldered parts are the bottom surface of the vertical and horizontal intersecting part 73c of the first ground connecting part 73 positioned in the center in the width direction of the first housing 11, a part of the bottom surface of the lower connecting part 72b of the first ground end connecting part 72, and a part of the bottom surface of the lower connecting part 71b of the first ground terminal 71 positioned on the outside in the width direction of the first housing 11. The connection pad to which the first ground member 70 is soldered to is connected to a conductive trace connected to a ground potential point, or in other words, to a ground line (reference potential wiring). Furthermore, for the first reinforcement fitting 51, the soldered parts are the bottom surface of the connecting feet parts 52g of the first end wall cover 52, the bottom surface of the connecting feet parts 53f of the first side wall cover 53, and the bottom surface of the connecting feet parts 54f of the first side plate 54. The connection pad to which the first reinforcement fitting 51 is soldered is connected to a ground line (reference potential wiring).

Note that for the first ground member 70, the soldered part can be a larger portion than the part indicated in the example in FIG. 6, if necessary. For example, the entire bottom surface of the first ground connecting part 73 can be a soldered part, the entire bottom surface of the lower connecting part 72b of the first ground end connecting part 72 can be a soldered part, and the entire bottom surface of the lower connecting part 71b of the first ground terminal 71 can be a soldered part. By enlarging the soldered part, electrical path length from each part of the first ground member 70 to the ground line can be shortened, further improving the shielding property of the first ground member 70, and further reducing crosstalk. Note that if the frequency of the electrical signal transmitted by the first signal terminal 61 is low, the soldered part on the bottom surface of the lower connecting part 71b of the first ground terminal 71 can be omitted.

In this manner, for the first connector 1, the first ground terminals 71 connected to the ground line are arranged between the first signal terminals 61 adjacent to each other in each terminal group row. In addition, the inclined elastic arm 53b of the first reinforcement fitting 51 connected to the ground line is arranged outwards on the first signal terminals 61 positioned on both ends on each terminal group row. Furthermore, the vertical shaft part 73a of the first ground connecting part 73 connected to the ground line is arranged between the first signal terminals 61 in the first terminal group row and the opposing first signal terminal 61 in the second terminal group row. Furthermore, the first side plate 54 of the first reinforcement fitting 51 connected to the ground line is arranged on the outside of the terminal group rows. This effectively shields each of the first signal terminals 61 since they are surrounded on all sides by conductive members connected to the ground line, effectively preventing crosstalk between the first signal terminals 61.

Next, the configuration of the second connector 101 will be described.

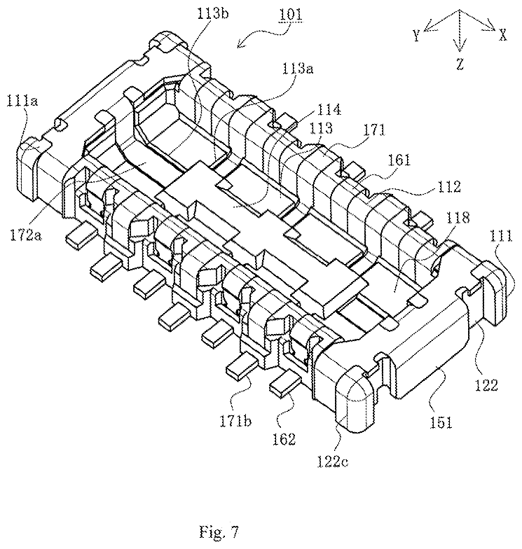

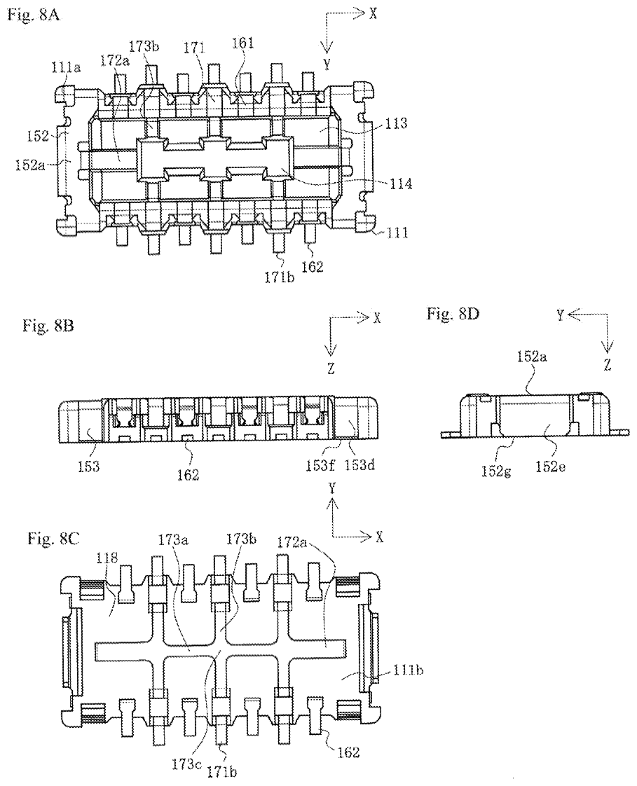

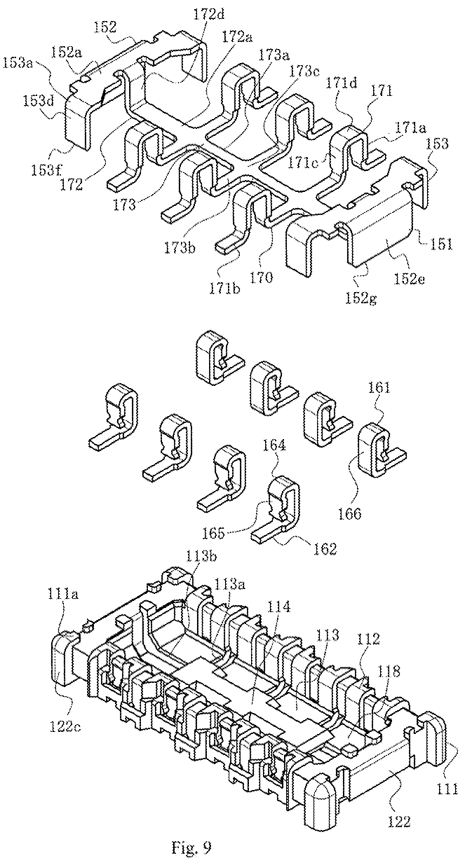

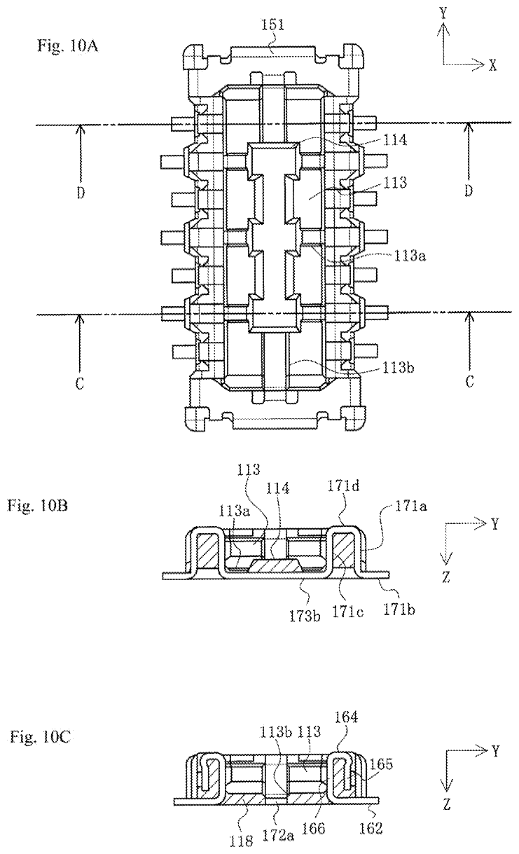

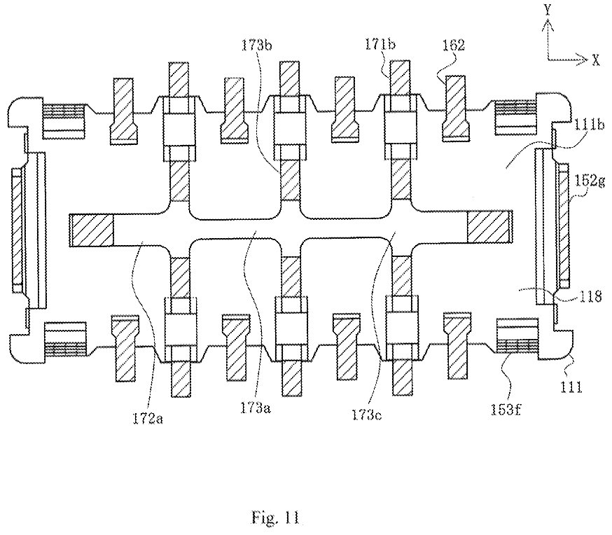

FIG. 7 is a perspective view of the second connector of embodiment 1. FIG. 8 is a four-plane diagram of the second connector of embodiment 1. FIG. 9 is an exploded view of the second connector of embodiment 1. FIG. 10 is a plan view and a cross-sectional view of the second connector of embodiment 1. FIG. 11 is a bottom view illustrating solder connections of the second connector of embodiment 1. Note, in FIG. 8, (a) is a plan view, (b) is a side view, (c) is a bottom view, and (d) is a front view. In FIG. 10, (a) is a plan view, (b) is a sectional view taken along the line C-C in (a), and (c) is a sectional view taken along the line D-D in (a).

The second connector 101 as a connector according to the present embodiment has the second housing 111 as a second connector body that is a connector body integrally formed of an insulating material such as synthetic resin. As illustrated in the figure, the second housing 111 has a substantially rectangular thick plate-like shape that is a substantially rectangular parallelepiped. A second recessed groove part 113 that extends in the longitudinal direction (X-axis negative direction) of the second housing 111, second side wall parts 112 that are elongated protrusions defining both sides of the second recessed groove part 113 in the width direction (Y-axis direction) and extending in the longitudinal direction of the second housing 111, and second protruding end parts 122 that define both ends of the second recessed groove part 113 in the longitudinal direction (X-axis direction) and extend in the width direction (Y-axis direction) of the second housing 111 to function as mating guides coupling both longitudinal ends of the second side wall part 112 are integrally formed on the side mated into the first connector 1 of the second housing 111, namely, on the side of the mating surface 111a (the side in the Z-axis negative direction).

The second side wall parts 112 are formed in parallel along both sides of the second recessed groove part 113 and along both sides of the second housing 111. The second signal terminals 161 as terminals are disposed on each of the second side wall parts 112. Furthermore, for each of the second side wall parts 112, a second ground terminal 171 is arranged in between the mutually adjacent second signal terminals 161 as a ground terminal. The second signal terminal 161 and second ground terminal 171 are arranged at a pitch corresponding to the first signal terminal 61 and first ground terminal 71, and in corresponding numbers. In the present embodiment, if the second signal terminal 161 and second ground terminal 171 are described in an integrated manner, they are to be described as second terminals. In other words, a plurality of the second terminals are arranged along each second side wall part 112 forming a pair of terminal group rows that are parallel. In addition, in the second recessed groove part 113, the side mounted on the second substrate, in other words, mounting surface 111b (the side in a positive Z-axis direction) is closed by a bottom plate 118.

The second signal terminal 161 is a member integrally formed by punching, bending, or the like on a conductive metal plate, and has:
an inner contact part 166,
a tail part 162 as a board connecting part connected to the bottom end of the inner contact part 166,
an upper connecting part 164 connected to the top end of the inner contact part 166, and
an outer contact part 165 connected to the bottom end of the upper connecting part 164 and facing the inner contact part 166.

The second signal terminals 161 may be integrated with the second housing 111 by over-molding or insert molding. That is, the second housing 111 is molded by filling a cavity of a mold in which the second signal terminals 161 are set in advance with an insulating material such as a synthetic resin. As a result, the second signal terminals 161 are at least partially embedded in the second housing 111 and are integrally attached to the second housing 111. Note that the second signal terminal 161 is not necessarily integrated with the second housing 111 by overmolding or insert molding, but may be attached to the second housing 111 by press fitting or the like. Here, for convenience of description, only a case in which the second housing 111 is integrated by overmolding or insert molding will be described.

The outer contact part 165 is at least partially exposed on a surface of the second side wall part 112, which faces the outer side of the second housing 111 in the width direction. Furthermore, the upper connecting part 164 is exposed on the upper surface (Z-axis negative direction) of the second side wall part 112, and is substantially flush with the surface. Furthermore, the inner contact part 166 is exposed on the surface facing the inner side of the second housing 111 in the width direction, and is substantially flush with the surface. The tail part 162 extends from the lower end of the surface facing the outer side of the second side wall part 112 in the width direction of the second housing 111 toward the outer side of the second housing 111 in the width direction and the bottom surface thereof (Z-axis side surface in the positive direction) is connected to a connection pad coupled to a conductive trace of the second substrate by soldering. Furthermore, as illustrated in FIG. 10(c), the elongated strip material constituting the second signal terminal 161 extends from the tip of the tail part 162 (outer end in the width direction of the second housing 111) at an approximately 90 degrees to the surface facing the inner side in the width direction of the second housing 111 of the second side wall part 112, and subsequently, extends at an approximately 90 degree angle from the lower end of the inner contact part 166, and then the upper connecting part 164 extends toward the outside in the width direction of the second housing 111, bends approximately 90 degrees, and is then bent so as to extend from the top toward the bottom of the outer contact part 165. In other words, the second signal terminal 161, as viewed from the longitudinal direction of the second housing 111, has a winding shape that proceeds inwards from the outside in the width direction of the second housing 111 and then winds around and a winding shape that winds upward and then winds backward.

As illustrated in FIG. 9, the second ground terminal 171 is a portion of the second ground member 170 and they are connected to each other. The second ground member 170 consists of a plurality of second ground terminals 171, a pair of second ground end connecting parts 172 arranged near both ends in the longitudinal direction (X-axis direction) of the second housing 111, and second ground connecting parts 173 that connect the plurality of second ground end connecting parts 171 and the pair of second ground end connecting parts 172. Note that the second ground member 170 is a member integrally formed by punching, bending or other processing of a metal plate, moreover, the second ground end connecting part 172 is integrally connected to the second reinforcement fitting 151.

Each of the second ground terminals 171 includes:
an outer contact part 171a,
an upper connecting part 171d connected to the top end of the outer contact part 171a,
an inner contact part 171c connected to the bottom end of the upper connecting part 171d and facing the outer contact part 171a, and
a tail part 171b as a board connecting part connected to the bottom end of the outer contact part 171a.

The outer contact part 171a is at least partially exposed on a surface of the second side wall part 112, which faces the outer side of the second housing 111 in the width direction. Furthermore, the upper connecting part 171d is exposed on the upper surface (Z-axis negative direction) of the second side wall part 112, and is substantially flush with the surface. Furthermore, the inner contact part 171c is exposed on the surface facing the inner side of the second housing 111 in the width direction, and is substantially flush with the surface. The tail part 171b extends from the lower end of the surface facing the outer side of the second side wall part 112 in the width direction of the second housing 111 toward the outer side of the second housing 111 in the width direction and the bottom surface thereof (Z-axis side surface in the positive direction) is connected to a connection pad coupled to a conductive trace of the second substrate by soldering. As illustrated in FIG. 10(b), the elongated strip material constituting the second ground terminal 171 extends from the tip of the tail part 171b (the outer end in the width direction of the second housing 111) to the surface facing the outer side in the width direction of the second housing 111 in the second side wall part 112, is bent approximately 90 degrees, extends from the bottom to the top of the outer contact part 171a, and is bent approximately 90 degrees at the upper end thereof. The upper connecting part 171d extends toward the inside of the second housing 111 in the width direction, is bent approximately 90 degrees, extends from the top to the bottom of the inner contact part 171c, the bottom end of which is connected to the tip end of a horizontal shaft part 173b of a second ground connecting part 173 bent approximately 90 degrees. In other words, the second ground terminal 171, as viewed from the longitudinal direction of the second housing 111, has a winding shape that proceeds inwards from the outside in the width direction of the second housing 111 and then winds around and a winding shape that winds upward and then winds forward. That is to say, that the second ground terminal 171 is wound in a different direction from the second signal terminal 161.

In addition, each of the second ground end connecting parts 172 have a vertical shaft part 172a and an upper connecting part 172d bent and connected to the tip of the vertical shaft part 172a. The vertical shaft part 172a is a strip-shaped member that extends linearly in the longitudinal direction of the second housing 111. In addition, the upper connecting part 172d is a strip-shaped member that extends from the tip of the vertical shaft part 172a upward (Z-axis negative direction), and the tip thereof, or in other words the upper end, is bent and connected to the upper surface portion 152a of the second end wall covering part 152 of the second reinforcement fitting 151.

The second ground connecting part 173 has a strip-shaped vertical shaft part 173a that extends linearly in the longitudinal direction of the second housing 111, and a plurality of pairs (in the example, three pairs) of horizontal shaft parts 173b that extend outward toward the width direction of the second housing 111 from both sides of the vertical shaft part 173a in a plurality of locations (in the example, three locations) along the longitudinal direction of the vertical shaft part 173a. The portion where the horizontal shaft part 173b extends from both sides of the vertical shaft part 173a is a vertical and horizontal intersecting part 173c which is a connecting part for the vertical shaft part 173a and horizontal shaft part 173b, and the vertical and horizontal intersecting part 173c in plan view (seen from the vertical direction) has a + shape.

Note that with the vertical and horizontal intersecting parts 173c, the base end of the vertical shaft part 172a of the second ground end connecting part 172 is connected to the vertical and horizontal intersecting parts 173c positioned on each of both longitudinal ends of the second housing 111. In the example as illustrated in the drawing, the vertical shaft part 172a of the second ground end connecting part 172 is formed wider than the vertical shaft part 173a of the second ground connecting part 173. In addition, the horizontal shaft part 173b extending in the left-right direction (Y-axis direction) has the tip thereof bent and connected toward the lower end of the inner contact part 171c of the second ground terminal 171. In this manner, all second ground terminals 171, second ground end connecting parts 172, and second ground connecting parts 173 of the second ground member 170 are mechanically and electrically connected.

On the upper surface of the second recessed groove part 113 of the second housing 111, a protrusion 114 is formed protruding upward in locations corresponding to the vertical shaft part 173a and vertical and horizontal intersecting parts 173c of the second ground connecting part 173, and the entire vertical shaft part 173a and vertical and horizontal intersecting part 173c and a part of the horizontal shaft part 173b are covered by the protrusion 114. This allows the insulating material such as the synthetic resin constituting the second housing 111 to flow smoothly during overmolding or insert molding. Furthermore, the protrusion 114 is housed in the upper surface recessed part 13b formed in the upper surface first protrusion 13 of the first housing 11 in a state where the first connector 1 and the second connector 101 are mated. In addition, a horizontal shaft housing recessed part 113a and vertical shaft housing recessed part 113b are formed on the second recessed groove part 113, where a part of the horizontal shaft part 173b of the second ground connecting part 173 is housed in the horizontal shaft housing recessed part 113a with the top surface thereof exposed, and a major portion of the vertical shaft part 172a of the second ground end connecting part 172 is housed in the vertical shaft housing recessed part 113b with the top surface thereof exposed.

A second reinforcement fitting 151 that is a reinforcing fitting mounted thereto is attached to the second housing 111. In the present embodiment, the second reinforcement fittings 151 are members integrally formed by performing processing such as punching or bending a metal plate, being members integrally connected to the second ground member 170, and are positioned at both longitudinal ends of the second housing 111, and each have a second end wall covering part 152 that covers a majority of the upper surface of the second protruding end part 122, and a second side wall covering part 153 that is connected to the side end of the second end wall covering part 152 and covers a majority of the side surface 122c.

The second end wall covering part 152 includes an upper surface portion 152a that extends in the width direction of the second housing 111 and covers the upper surface 122a of the second protruding end part 122, an outer cover portion 152e that extends downward from the outer edge of the second protruding end part 122 on the upper surface portion 152a, an engaging projection 152f that protrudes from the side edge of the outer cover portion 152e, and connecting feet parts 152g at a lower end of the outer cover part 152e. The upper end of the upper connecting part 172d of the second ground end connecting part 172 is bent and connected to the center portion of the inner edge of the second protruding end part 122 of the upper surface portion 152a.

The second side wall covering part 153 includes an upper surface part 153a that extends in the longitudinal direction of the second housing 111 and covers the vicinity of the side edge of the upper surface of the second protruding end part 122, an outer cover portion 153d that extends downward from the side edge of the second side wall covering part 153 on the upper surface part 153a, and connecting feet parts 153f at the lower end of the outer cover portion 153d.

The second reinforcement fitting 151, together with the second ground member 170, is integrated with the second housing 111 by overmolding or insert molding. In other words, the second housing 111 is molded by filling the cavity of a mold, in which the second reinforcement fitting 151 and second ground member 170 have been set beforehand, with an insulating material such as synthetic resin. As a result, at least a portion of the second reinforcement fitting 151 and second ground member 170 are embedded in the second housing 111 so as to be integrally attached to the second housing 111. Note that the second reinforcement fitting 151 and second ground member 170 are not necessarily integrated with the second housing 111 by overmolding or insert molding, but may be attached to the second housing 111 by press fitting or the like. Here, for convenience of description, only a case in which the second housing 111 is integrated by overmolding or insert molding will be described.

In a state where the second reinforcement fitting 151 is attached to the second housing 111, the bottom surface of the connecting feet parts 152g of the second end wall covering part 152 are positioned lower than the mounting surface 111b, or in other words the bottom surface of the bottom plate 118 (surface in the Z-axis positive direction), and are substantially flush with the bottom surface of the tail part 162 of the second signal terminal 161. In addition, the bottom surface of the connecting feet parts 153f of the second side wall covering part 153 are positioned flush or lower than the mounting surface 111b, and are substantially flush with the bottom surface with the tail part 162 of the second signal terminal 161.

As described above, since a majority of the surface of the second protrusion end 122 is covered with the second reinforcement fitting 151, the strength of the second protrusion end 122 increases, and even when a force or impact is applied to the second protrusion end 122 in the operation of fitting the first connector 1 and the second connector 101 together, damage or deformation of the second protrusion end 122 can be reliably prevented. In addition, the second end wall covering part 152 positioned on each of both longitudinal ends of the second housing 111 are connected by the second ground member 170, making the overall strength of the second reinforcement fitting 151 high, effectively reinforcing the second housing 111.

In FIG. 11, which is a bottom view of the second connector 101, parts of the second signal terminal 161, second ground member 170, and second reinforcement fitting 151 that are exposed on the mounting surface 111b and connected to the conductive trace of the second board via soldering to the soldering pad, or in other words, soldered parts, are indicated by shaded lines (hatching). For the second signal terminal 161, the only soldered part is the bottom surface of the tail part 162, and the connection pad to which the bottom surface of the tail part 162 is soldered to is connected to a conductive trace that transmits an electrical signal, or in other words, to a signal line. In addition, for the second ground member 170, the soldered parts are the bottom surface of the horizontal shaft part 173b of the second ground connecting part 173, a part of the bottom surface of the vertical shaft part 172a of the second ground end connecting part 172 positioned in the center of the width direction of the second housing 111, and the bottom surface of the tail part 171b of the second ground terminal 171 positioned on the outside in the width direction of the second housing 111. The connection pad to which the second ground member 170 is soldered to is connected to a conductive trace connected to a ground potential point, or in other words, to a ground line (reference potential wiring). Furthermore, for the second reinforcement fitting 151, the soldered parts are the bottom surface of the connecting feet parts 152g of the second end wall covering part 152 and the bottom surface of the connecting feet parts 153f of the second side wall covering part 153. The connection pad to which the second reinforcement fitting 151 is soldered to is connected to a ground line (reference potential wiring).

Note that for the second ground member 170, the soldered part can take a larger portion than the part indicated in the example in FIG. 11, if necessary. For example, the entire bottom surface of the second ground connecting part 173 can be a soldered part, and the entire bottom surface of the vertical shaft part 172b of the second ground end connecting part 172 can be a soldered part. By enlarging the soldered part, electrical path length from each part of the second ground member 170 to the ground line can be shortened, further improving the shielding property of the second ground member 170, and further reducing crosstalk.

In this manner, for the second connector 101, the second ground terminals 171 connected to the ground line are arranged between the second signal terminals 161 adjacent to each other in each terminal group row. In addition, the second side wall covering part 153 of the second reinforcement fitting 151 connected to the ground line is arranged outwards on the second signal terminals 161 positioned on both ends on each terminal group row. Furthermore, the vertical shaft part 173a of the second ground connecting part 173 connected to the ground line is arranged between the second signal terminal 161 in the first terminal group row and the second signal terminal 161 in the second terminal group row. This effectively shields each of the second signal terminals 161 since they are surrounded on four sides by conductive members connected to the ground line, effectively preventing crosstalk between the second signal terminals 161.

Subsequently, the operation of mating together the first connector 1 and the second connector 101 with the above configuration will be described.

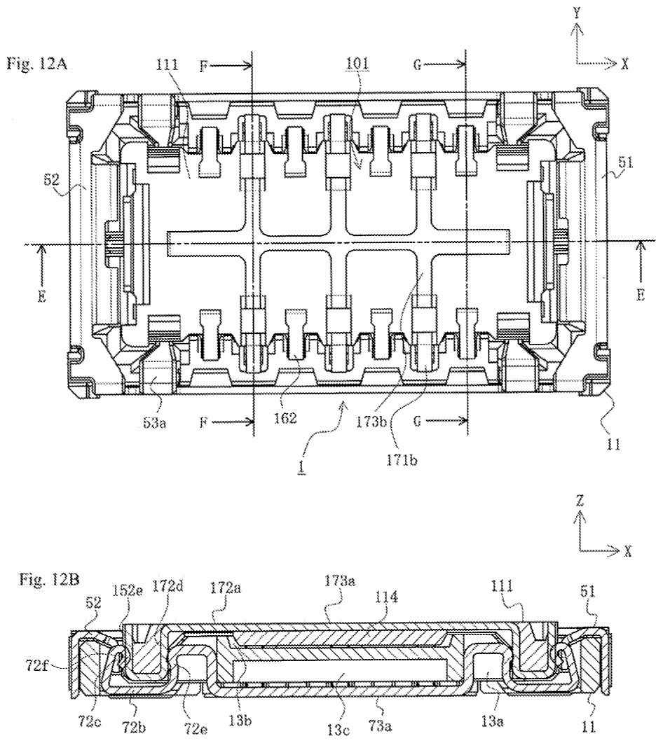

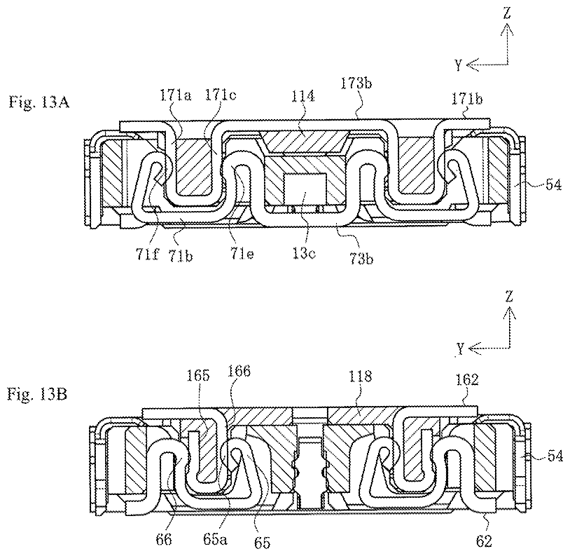

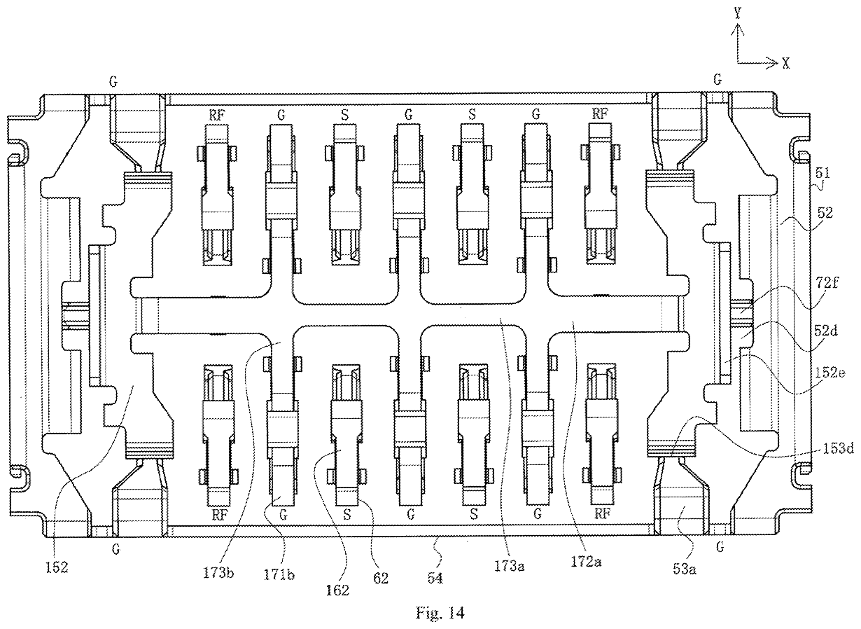

FIG. 12 is a plan view and cross-sectional view of a state in which the first connector and second connector of the embodiment 1 are mated. FIG. 13 is a cross-sectional view of a state in which the first connector and second connector of the embodiment 1 are mated. FIG. 14 is a diagram of a state in which the first connector and second connector of the embodiment 1 are mated and where the first housing and second housing are omitted in a plan view. In FIG. 12, (a) is a plan view, (b) is a sectional view taken along the line E-E in (a). In FIG. 13, (a) is a sectional view taken along the line F-F In FIGS. 12(a) and (b) is a sectional view taken along the line G-G in FIG. 12(a).

Here, as illustrated by the diagonal lines (hatching) in FIG. 6, the soldered portions of the first signal terminal 61, first ground member 70, and first reinforcement fitting 51 of the first connector 1 are connected by solder to connection pads connecting to a conductive trace on the first board (not shown) and are thus surface mounted on the first board. Similarly, as illustrated by the diagonal lines in FIG. 11, the soldered portions of the second signal terminal 161, second ground member 170, and second reinforcement fitting 151 of the second connector 101 are connected by solder to connection pads connecting to a conductive trace on the second board (not shown) and are thus surface mounted on the second board.

First, when an operator makes a mating surface 11a of the first housing 11 of the first connector 1 face the mating surface 111a of the second housing 111 of the second connector 101, the position of the second side wall part 112 of the second connector 101 coincides with the position of the corresponding first recessed groove part 12a of the first connector 1, while the position of the second protruding end part 122 of the second connector 101 coincides with the position of the corresponding mating recess 22 of the first connector 1, thereby completing the alignment between the first connector 1 and the second connector 101.

In this state, when the first connector 1 and/or the second connector 101 is moved in a direction approaching the counterpart, that is, in the mating direction (Z-axis direction), the second side wall part 112 and the second protruding end part 122 of the second connector 101 are inserted into the first recessed groove part 12a and the mating recess 22 of the first connector 1. Consequently, as illustrated in FIG. 1 and FIG. 12, when the mating between the first connector 1 and the second connector 101 is completed, the first signal terminal 61 and the second signal terminal 161 enter into a conduction state, the first ground terminal 71 and the second ground terminal 171 enter into a conduction state, and the first reinforcement fitting 51 and the second reinforcement fitting 151 enter into a conduction state.

Specifically, as illustrated in FIG. 13(b), when the corresponding second signal terminal 161 is inserted between the inner contact part 65a and the outer contact part 66 of each first signal terminal 61, the inner contact part 65a of the first signal terminal 61 and the inner contact part 166 of the second signal terminal 161 come into contact with each other, and the outer contact part 66 of the first signal terminal 61 and the outer contact part 165 of the second signal terminal 161 come into contact with each other. As a result, since the first signal terminal 61 and the corresponding second signal terminal 161 come into contact with each other at two locations, that is, are in a so-called multiple contact state, even when one contact is separated due to shock or vibration, the conduction state can be maintained.

Similarly, as illustrated in FIG. 13(a), the corresponding second ground terminal 171 is inserted between the inner contact part 71e and outer contact part 71f of each first ground terminal 71, the inner contact part 71e of the first ground terminal 71 and the inner contact part 171c of the second ground terminal 171 come into contact and the outer contact part 71f of the first ground terminal 71 and the outer contact part 171a of the second ground terminal 171 come into contact. As a result, since the first ground terminal 71 and the corresponding second ground terminal 171 come into contact with each other at two locations, that is, are in a so-called multiple contact state, even when one contact is separated due to shock or vibration, the conduction state can be maintained.

Furthermore, the contact protrusion 53c of the inclined elastic arm 53b of the first reinforcement fitting 51 engages and comes into contact with the second side wall covering part 153 outer cover portion 153d of the corresponding second reinforcement fitting 151. As a result, even when the first reinforcement fitting 51 and the corresponding second reinforcement fitting 151 are subjected to shock or vibration, the elastically displaceable contact protrusion 53c maintains contact with the outer cover portion 153d such that the conduction state can be maintained.

Furthermore, as illustrated in FIG. 12(b), the corresponding second end wall covering part 152 of the second reinforcement fitting 151 is inserted between the inner contact part 72e of each first ground end connecting part 72 and the outer contact part 72f. Thus, the inner contact part 72e of the first ground end connecting part 72 contacts the upper connecting part 172d of the second ground end connecting part 172 in contact with the upper surface portion 152a of the second end wall covering part 152 and the outer contact part 72f of the first ground end connecting part 72 contacts the outer cover part 152e of the second end wall covering part 152. As a result, the first ground member 70 and mutually connected second ground member 170 and second reinforcement fitting 151 are connected in two locations, a so-called multiple contact point state so that even if one contact point separates due to shock or vibration, the conductive state can be maintained.

In this manner, the first grounding member 70, the first reinforcement fitting 51, the second grounding member 170 and the second reinforcement fitting 151 are in contact with each other and conduct, making them equipotential, thus improving the shielding property.

The first connector 1 and second connector 101 of the present embodiment can be used as a connector assembly for connecting conductive traces for transmitting various types of current to electrical signals; however, herein, codes S, RF, and G are indicated in FIG. 14 for the first signal terminal 61, the first ground terminal 71, the second signal terminal 161, the second ground terminal 171, the inclined elastic arm 53b of the first reinforcement fitting 51, and the outer cover portion 153d of the second reinforcement fitting 151 second side wall covering part 153. These indicate a normal signal terminal (S) that is connected to a normal signal line and transmits normal frequency (for example, frequencies less than 10 [GHz]) signals, high frequency signal terminals (RF) that are connected to a high frequency signal line and transmits high frequencies (for example, frequencies of 10 [GHz] or higher) such as RF signals, and ground terminals (G) connected to a ground line that is reference potential wiring.

In this case, the first signal terminal 61 that is a high frequency signal terminal (RF) and the first ground terminal 71 and second ground terminal 171 that are ground terminals (G) as well as the inclined elastic arm 53b of the first reinforcement fitting 51 and the second side wall covering part 153 outer cover portion 153d of the second reinforcement fitting 151 are positioned on both sides of the second signal terminal 161 in the X-axis direction in plan view. In addition, the first ground end connecting part 72 and second ground end connecting part 172 connected to a ground line as well as the first side plate 54 of the first reinforcement fitting 51 are positioned on both sides of the first signal terminal 61 and second signal terminal 161 in the Y-axis direction so the first signal terminal 61 and second signal terminal 161 are encircled continuously on four sides by conductive members connected to a ground line. In other words, a pseudo-waveguide is formed around the first signal terminal 61 and second signal terminal 161, which are high frequency signal terminals (RF). Therefore, high frequency signals that are transmitted using high frequency signal terminals (RF) are not influenced by external noise and do not cause any external noise effects.

Further, in a plan view, the high frequency signal terminals (RF) positioned on the right side and the left side in the width direction (Y-axis direction) of the first connector 1 and the second connector 101 are arranged symmetrically with the centerline of the first connector 1 and second connector 101 in the width direction as an axis of symmetry and are facing each other with the first ground end connecting part 72 and second ground end connecting part 172 that extends along said centerline interposed therebetween. In this manner, by interposing of the first ground end connecting part 72 and second ground end connecting part 172 connected to a ground line in between the mutually facing high frequency signal terminals (RF), they become less likely to interfere with each other, reducing crosstalk.

Further, in a plan view, the high frequency signal terminals (RF) positioned on the front and the back in the longitudinal direction (X-axis direction) of the first connector 1 and the second connector 101 are arranged symmetrically with the centerline of the first connector 1 and second connector 101 with the centerline in the longitudinal direction of the first connector 1 and second connector 101 as an axis of symmetry and are facing each other with a plurality of first ground terminals 71 and second ground terminals 171 interposed therebetween. In this manner, by interposing of the ground terminal (G) connected to a ground line in between the mutually facing high frequency signal terminals (RF), they become less likely to interfere with each other, reducing crosstalk.

Furthermore, the high frequency signal terminal (RF) near a first end of a first row of the first connector 1 and second connector 101 in the width direction and the high frequency signal terminal (RF) near a second end of a second row, in other words, in plan view, the first ground member 70 and second ground member 170 connected to a ground line are provided on the pseudo diagonal as a straight line connecting the high frequency signal terminals (RF) positioned near the diagonal of the first connector 1 and second connector 101. In this manner, as the first ground member 70 and second ground member 170 are interposed between the high frequency signal terminals (RF) positioned near the diagonal of the first connector 1 and second connector 101, crosstalk is reduced.

In addition, the first ground member 70 that includes the first ground terminal 71, first ground end connecting part 72, and the first ground connecting part 73 is an elongated member that extends in the longitudinal direction and width direction of the first connector 1. As illustrated in FIG. 6, a plurality of discrete soldered parts spread over a wide area are connected by solder to connection pads connected to a conductive trace as a first board ground line. Also, the first ground terminal 71 and first ground end connecting part 72 are in contact and conduct with the second ground terminal 171 and second reinforcement fitting 151 connected to a conductive trace as a second board ground line so the electrical path length to a ground line is short for all parts of the first ground member 70. As a result, since the first ground member 70 can exhibit high shielding properties, the high frequency signal terminals (RF) are less likely to interfere with each other, and crosstalk is reduced.

Furthermore, the first reinforcement fitting 51 that includes the inclined elastic arm 53b used as a ground terminal includes the first end wall cover 52, first side wall cover 53, first side plate 54 and is an elongated member extending in the longitudinal direction and the width direction of the first connector 1. As illustrated in FIG. 6, a plurality of discrete soldered parts spread over a wide area are connected by solder to connection pads connected to a conductive trace as a first board ground line. In addition, the inclined elastic arm 53b is in contact and conducts with the second reinforcement fitting 151 connected to the conductive trace as a second board ground line so the first reinforcement fitting 51 has a shorter electrical path length to the ground line in all the parts thereof. As a result, since the first reinforcement fitting 51 can exhibit high shielding properties, the high frequency signal terminals (RF) are less likely to interfere with each other, and crosstalk is reduced.

Furthermore, the second ground member 170 and second reinforcement fitting 151 that includes the second ground terminal 171, second ground end connecting part 172, and the second ground connecting part 173 is an elongated member that extends in the longitudinal direction and width direction of the second connector 101. As illustrated in FIG. 11, a plurality of discrete soldered parts spread over a wide area are connected by solder to connection pads connected to a conductive trace as a second board ground line. Also, the second ground terminal 171, second ground end connecting part 172, and second reinforcement fitting 151 are in contact and conduct with the first ground terminal 71, first ground end connecting part 72, and first reinforcement fitting 51 connected to a conductive trace as a first board ground line so the electrical path length to a ground line is shortened for all parts of the second ground member 170. As a result, since the second ground member 170 can exhibit high shielding properties, the high frequency signal terminals (RF) are less likely to interfere with each other, and crosstalk is reduced.

Note that the present disclosure is not necessarily limited to this example, and the type of conductive trace connected to each of the first signal terminals 61, the first ground terminal 71, the first ground member 70, the first reinforcement fitting 51, the second signal terminal 161, the second ground terminal 171, the second ground member 170, and the second reinforcement fitting 151 can be changed as appropriate. Also, the number of the first signal terminals 61, the first ground terminals 71, the second signal terminals 161 and the second ground terminals 171 can also be changed.

Thus, with the present embodiment, the first connector 1 has a first housing 11 and a first signal terminal 61 and first ground terminal 71 that are first terminals mounted in the first housing 11 and which mate with the second connector 101. Furthermore, the first housing 11 includes a first recessed part 12 that mates with the second housing 111 of the second connector 101, the first side wall part 14 that extends in the longitudinal direction and demarcates both sides of the first recessed part 12, the first protrusion 13 extending in the longitudinal direction in the first recessed part 12, and the first recessed groove part 12a formed between the first protrusion 13 and first side wall part 14. A plurality of first terminals are arranged along each of the first recessed groove parts 12a forming a pair of parallel terminal group rows. Each of the terminal group rows includes at least a part of the first ground member 70; the first ground member 70 is exposed on the mounting surface 11b of the first housing 11 and is connected by solder to reference potential wiring positioned on the center part in the width direction and on the outside in the width direction of the first housing 11.

In addition the second connector 101 has a second housing 111 and a second signal terminal 161 and second ground terminal 171 that are second terminals mounted in the second housing 111 and which mate with the first connector 1. Furthermore, the second housing 111 extends in the longitudinal direction of the second recessed groove part 113 and second housing 111 and includes a pair of second side wall parts 112 arranged in parallel that demarcate both sides of the second recessed groove part 113. A plurality of second terminals are arranged along each second side wall part 112 forming a pair of parallel terminal group rows. Each terminal group row includes at least a part of the second ground member 170. The second ground member 170 is exposed on the mounting surface 111b of the second housing 111 and is connected by solder to reference potential wiring positioned at the center in the width direction and on the outside in the width direction of the second housing 111.

This increases the shield effect for the first connector 1 and second connector 101, reliably reducing crosstalk, and improving reliability.

Furthermore, a portion of the first ground member 70 included in each of the terminal group rows is a first ground terminal 71, and each first ground terminal 71 included in each of the terminal group rows are arranged in positions facing each other and connected via the first ground connecting part 73. Furthermore, the first connector 1 includes a first reinforcement fitting 51 that fully encircles the first housing 11 in plan view and the first reinforcement fitting 51 is connected to reference potential wiring at a plurality of soldered parts positioned on the outside of the first housing 11. Furthermore, a portion of the second ground member 170 included in each of the terminal group rows is a second ground terminal 171, and the second ground terminals 171 included in each of the terminal group rows are arranged in positions facing each other and connected via the second ground connecting part 173. Furthermore, the second housing 111 includes a second protruding end part 122 that is formed at both edges thereof in the longitudinal direction and inserted into the mating recess 22 formed in the first protruding end part 21 of the first connector 1. The second reinforcement fitting 151 connected to the second ground member 170 is mounted on the second protruding end part 122.

Next, Embodiment 2 will be described below. Note that, for portions having the same structure as that of Embodiment 1, descriptions thereof are omitted by giving the same reference numerals thereto. Moreover, descriptions of the same operations and effects as those of Embodiment 1 will be omitted.

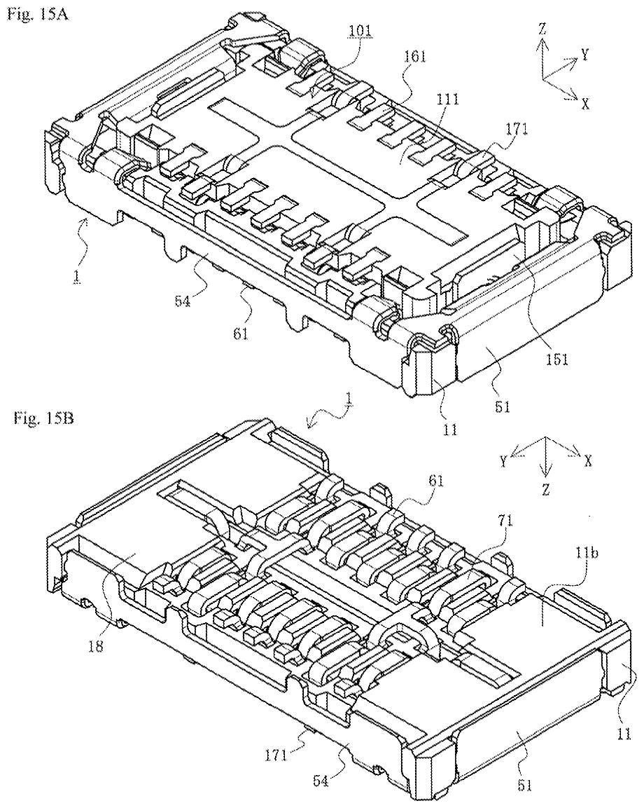

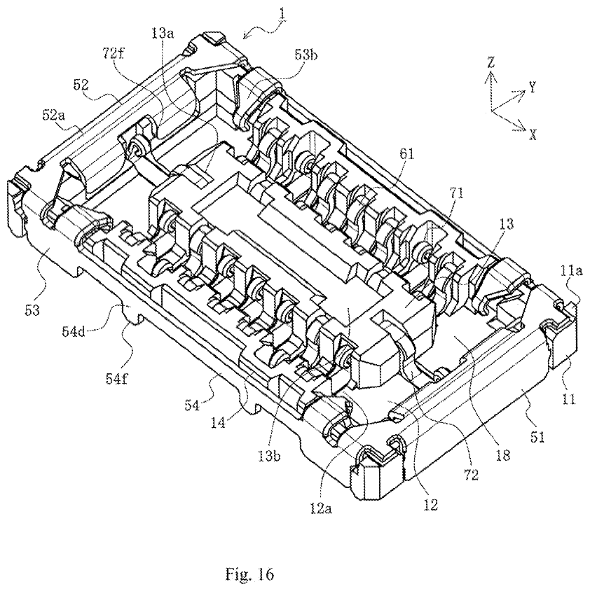

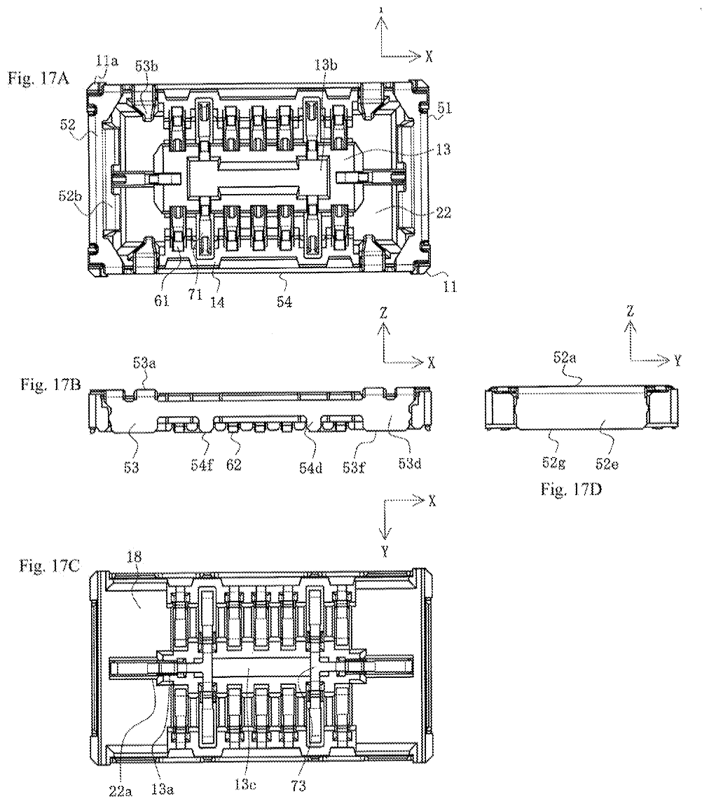

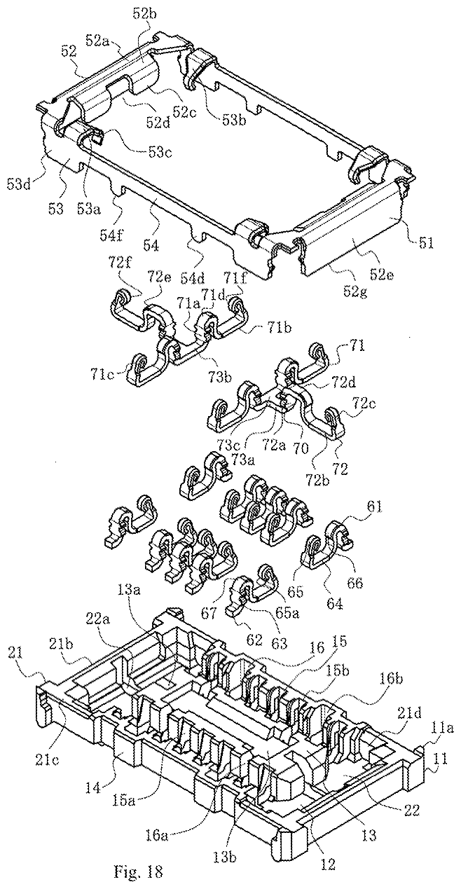

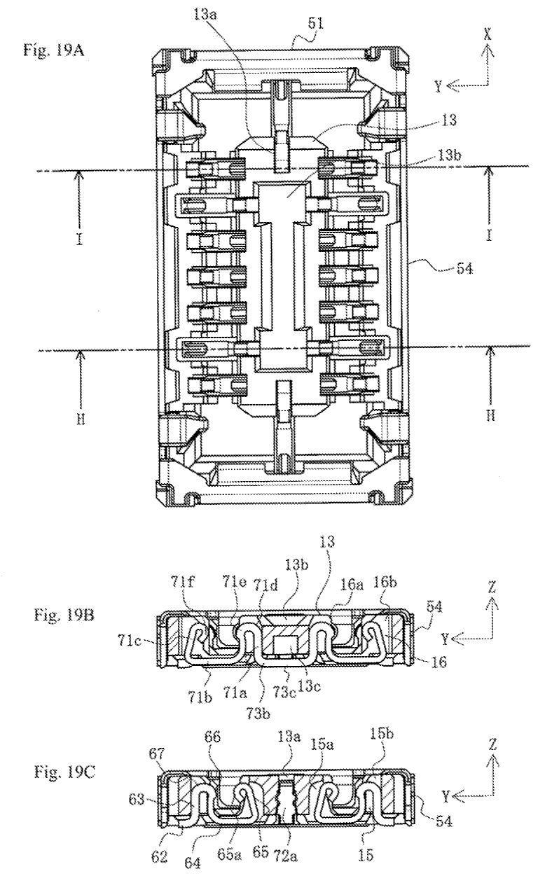

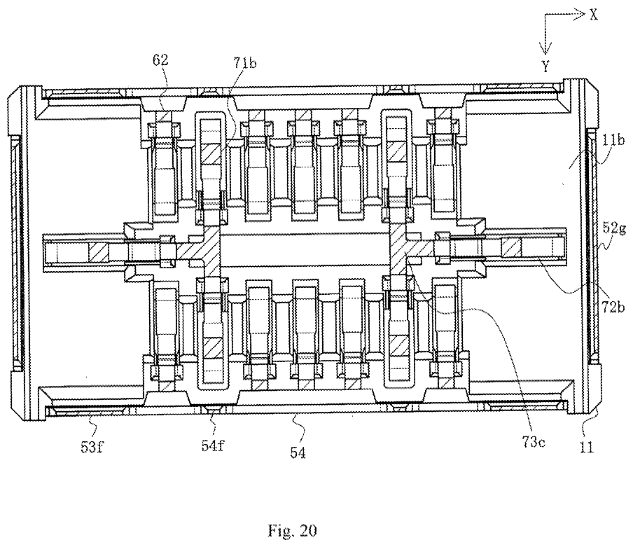

FIG. 15 is a perspective view of mating a first connector and a second connector according to embodiment 2. FIG. 16 is a perspective view of the first connector according to embodiment 2. FIG. 17 is a four-plane diagram of the first connector according to embodiment 2. FIG. 18 is an exploded view of the first connector according to embodiment 2. FIG. 19 is a plan view and cross-sectional view of the first connector according to embodiment 2. FIG. 20 is a bottom view of the solder locations of the first connector according to embodiment 2. Note that, in FIG. 15, (a) is a perspective view of the first connector as viewed from the mating surface, (b) is a perspective view of the first connector as viewed from the mounting surface. In FIG. 17, (a) is a plan view, (b) is a side view, (c) is a bottom view, and (d) is a front view. In FIG. 19, (a) is a plan view, (b) is a sectional view taken along the line A-A in (a), and (c) is a sectional view taken along the line B-B in (a).

With the first connector 1 of the present embodiment, the terminal arrangement differs from that of the first connector 1 of embodiment 1. In other words, with the first connector 1 of embodiment 1, first ground terminals 71 connected to a ground line are arranged in between the mutually adjacent first signal terminals 61 of each of the terminal group rows formed in two rows in the longitudinal direction of the first housing 11, whereas, with the first connector 1 of the present embodiment, there is only a first ground terminal 71 arranged adjacent to the inside of the first signal terminals 61 positioned at both ends of each terminal group row and no first ground terminals 71 are arranged at other positions. In the example shown in the drawing, one each of the first signal terminals 61 are arranged at each end of each terminal group row, and the first ground terminal 71 is arranged adjacent to the inside of the first signal terminal 61 in the longitudinal direction of the first housing 11; however, in other positions, three of the first signal terminals 61 are arranged in a row.

In a similar manner, with the first connector 1, the terminal storage cavity arrangement differs from that of the first connector 1 of embodiment 1. In other words, the first signal terminal housing cavities 15 that house the first signal terminals 61 and the first ground terminal housing cavity 16 that houses the first ground terminals 71 are arranged similar to the first signal terminals 61 and the first ground terminals 71.

In addition, the first ground members 70 of the present embodiment are divided into two sections in the longitudinal direction of the first connector 1 as illustrated in FIG. 18. Specifically, the first ground connecting part 73 is divided into two sections in the longitudinal direction of the first housing 11 and a pair of first ground end connecting parts 72 arranged at the end in the longitudinal direction (X-axis direction) of the first housing 11 are not connected to each other.

In further detail, in each of the first ground connecting parts 73, in plan view, the vertical and horizontal intersecting parts 73c that are a + shape in embodiment 1 are in a T shape here. The vertical shaft part 73a only extends outwards from the vertical and horizontal intersecting parts 73c in the longitudinal direction of the first housing 11 and does not extend inwards in the longitudinal direction of the first housing 11.

Note that a configuration of another point of the first connector 1 in the present embodiment is the same as that of Embodiment 1 described above, and therefore, a description thereof is omitted.

Next, the configuration of the second connector 101 will be described.

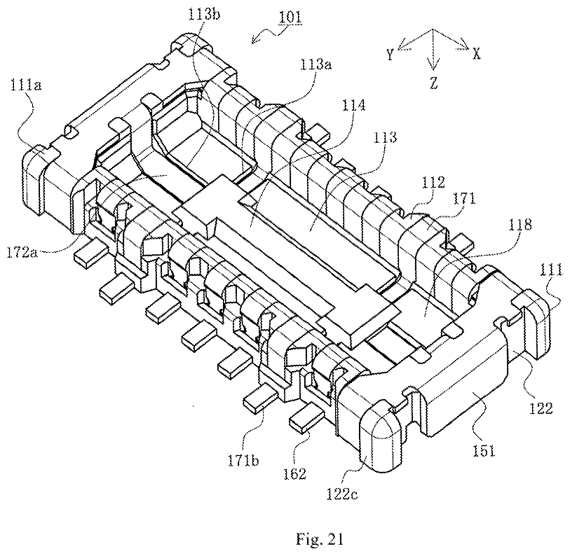

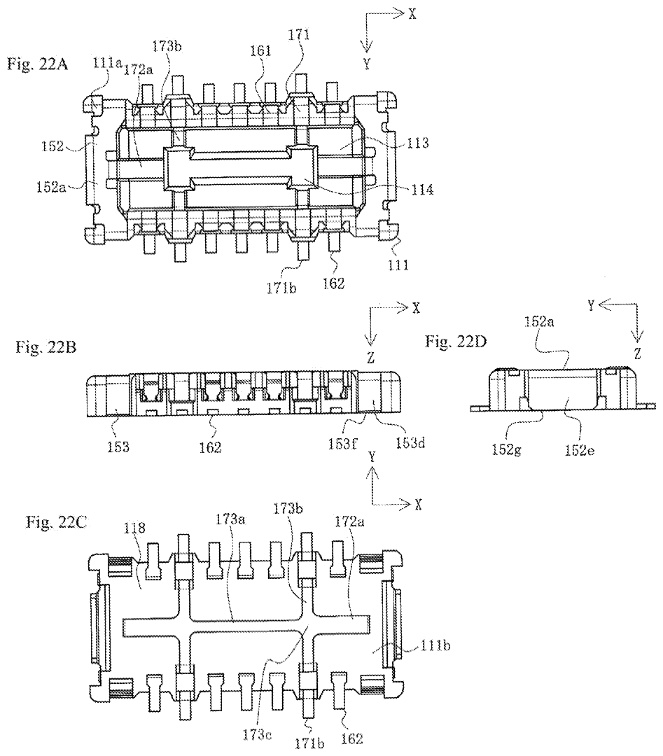

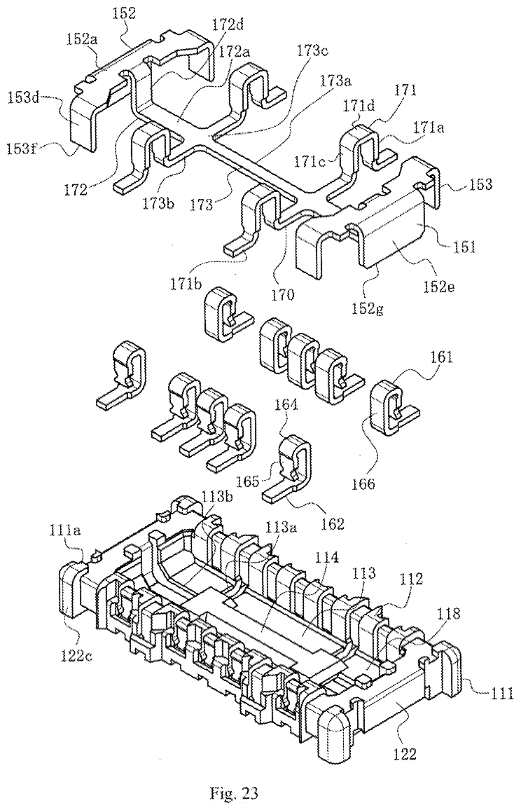

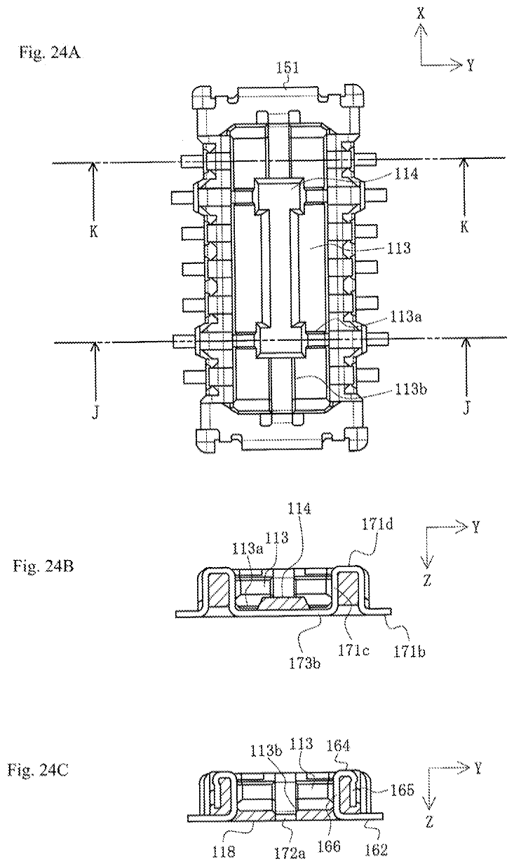

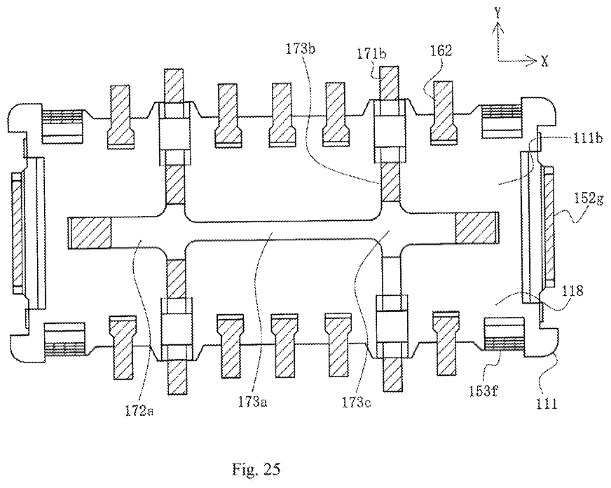

FIG. 21 is a perspective view of the second connector of embodiment 2. FIG. 22 is a four-plane diagram of the second connector of embodiment 2. FIG. 23 is an exploded view of the second connector of embodiment 2. FIG. 24 is a plan view and a cross-sectional view of the second connector of embodiment 2. FIG. 25 is a bottom view illustrating solder connections of the second connector of embodiment 2. Note, in FIG. 22 (a) is a plan view, (b) is a side view, (c) is a bottom view, and (d) is a front view. In FIG. 24, (a) is a plan view, (b) is a sectional view taken along the line J-J in (b), and (c) is a sectional view taken along the line K-K in (c).

With the second connector 101 of the present embodiment, similar to the case of the first connector 1, the terminal arrangement differs from that of the second connector 101 of embodiment 1. In other words, with the second connector 101 of embodiment 1, second ground terminals 171 connected to a ground line are arranged in between the mutually adjacent second signal terminal 161 of each of the terminal group rows formed in two rows in the longitudinal direction of the second housing 111, whereas, with the second connector 101 of the present embodiment, there is only a second ground terminal 171 arranged adjacent to the inside of the second signal terminal 161 positioned at both ends of each terminal group row and no second ground terminals 171 are arranged at other positions. In the example shown in the drawing, one each of the second signal terminals 161 are arranged at each end of each terminal group row, and the second ground terminals 171 are arranged adjacent to the inside of the second signal terminals 161 in the longitudinal direction of the second housing 111; however, in other positions, three of the second signal terminals 161 are arranged in a row.

Note that a configuration of another point of the second connector 101 in present embodiment is the same as that of Embodiment 1 described above, and therefore, a description thereof is omitted.

Subsequently, the operation of mating together the first connector 1 and the second connector 101 with the above configuration will be described.

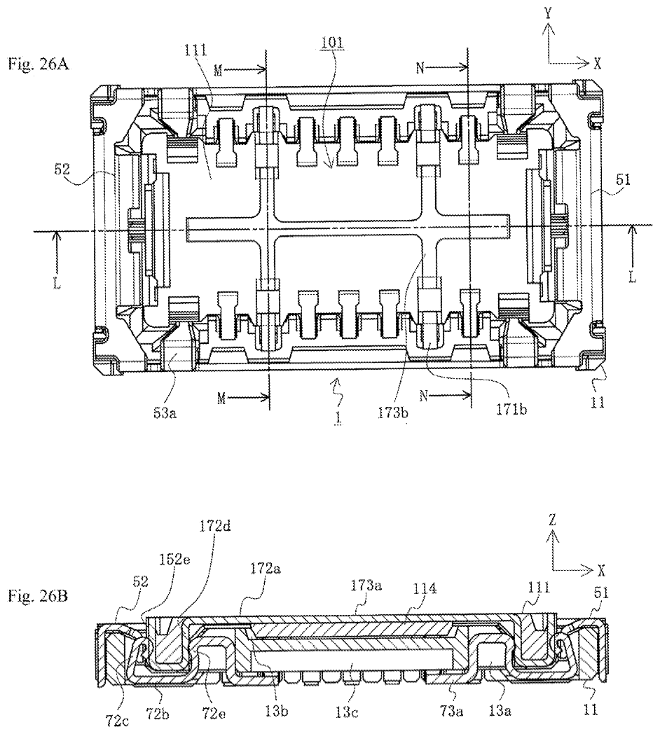

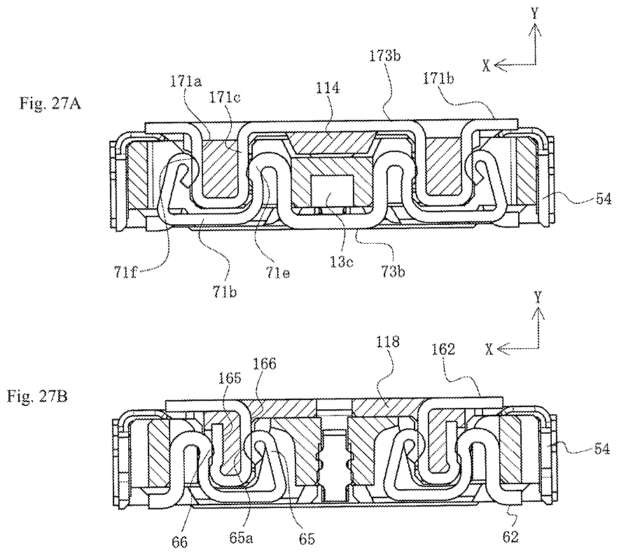

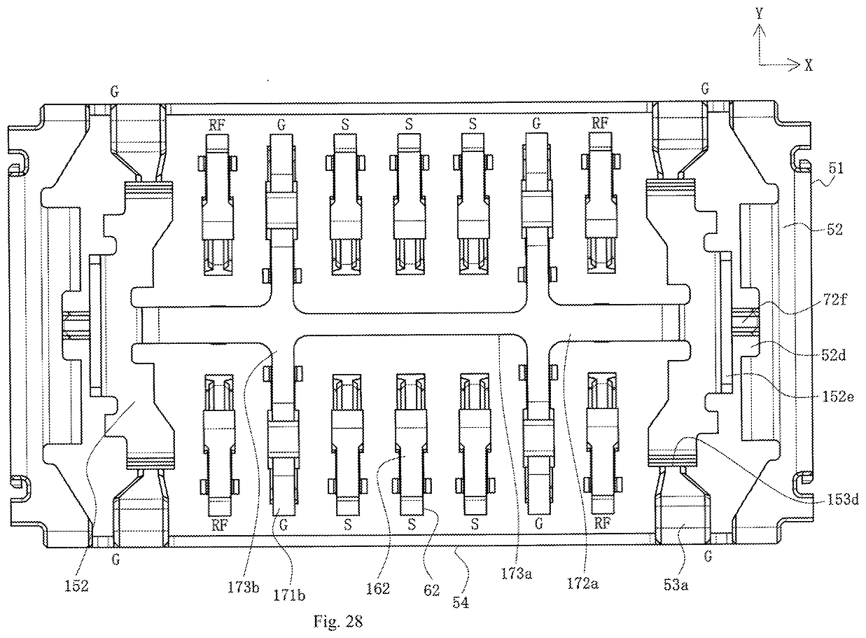

FIG. 26 is a plan view and cross-sectional view of a state in which the first connector and second connector of embodiment 2 are mated. FIG. 27 is a cross-sectional view of a state in which the first connector and second connector of the embodiment 2 are mated. FIG. 28 is a diagram of a state in which the first connector and second connector of the embodiment 2 are mated and where the first housing and second housing are omitted in a plan view. In FIG. 26, (a) is a plan view, (b) is a sectional view taken along the line L-L in (a). In FIG. 27, (a) is a sectional view taken along the line M-M in FIGS. 26(a) and (b) is a sectional view taken along the line N-N in FIG. 26(a).

Similar to embodiment 1, the first connector 1 and second connector 101 of the present embodiment can be used as a connector assembly for connecting conductive traces for transmitting various types of current to electrical signals; however, in the present embodiment, codes S, RF, and G are indicated in FIG. 28 for the first signal terminal 61, the first ground terminal 71, the second signal terminal 161, the second ground terminal 171, the inclined elastic arm 53b of the first reinforcement fitting 51, and the outer cover portion 153d of the second reinforcement fitting 151 second side wall covering part 153. These indicate a normal signal terminal (S) that is connected to a normal signal line and transmits normal frequency (for example, frequencies less than 10 [GHz]) signals, high frequency signal terminals (RF) that are connected to a high frequency signal line and transmits high frequencies (for example, frequencies of 10 [GHz] or higher) such as RF signals, and ground terminals (G) connected to a ground line.

In the example illustrated in embodiment 1, there are three ground terminals interposed between the high frequency signal terminals (RF) positioned at the front and the back in the longitudinal direction of the first connector 1 and the second connector 101; while in the example of the present embodiment, there are two ground terminals interposed between the high frequency signal terminals (RF).

Note that an operation of mating the first connector 1 and the second connector 101 in the present embodiment and configurations and effects of the state of being mated and other points of the first connector 1 and the second connector 101 are the same as those of embodiment 1 described above, and therefore, descriptions thereof are omitted.

Moreover, the disclosure herein describes features relating to suitable typical embodiments. Various other embodiments, modifications, and variations within the scope and spirit of the claims appended hereto will naturally be conceived of by those skilled in the art upon review of the disclosure herein.

The present disclosure can be applied to a connector.

1. A first connector comprising:
(a) a first connector body, and
a first terminal mounted to the first connector body, wherein
(b) the first connector body includes:
a first recessed part,
a first side wall part extending in the longitudinal direction that demarcates both sides of the first recessed part,
an islet extending in the longitudinal direction inside the first recessed part, and
a first recessed groove part formed between this islet and the first side wall part, and
(c) a plurality of the first terminals are arranged along each first recessed groove part forming a pair of parallel terminal group rows,
each of the terminal group rows includes at least a part of a first ground member,
the first ground member is exposed on the mounting surface of the first connector body and connected by solder to reference potential wiring positioned to the center as well as to the outside in the width direction of the first connector body.

2. The first connector according to claim 1, wherein a portion of the first ground member included in each of the terminal group rows is a first ground terminal, and each of the first ground terminals included in each of the terminal group rows are arranged in a position facing each other and connected via the first ground connecting part.

3. The first connector according to claim 1 or 2, wherein as viewed in plan view, the first connector further has a shield member that continuously surrounds the first connector main body, and said shield member is connected to reference potential wiring at a plurality of solder locations positioned on the exterior of the first connector body.

4. A connector pair, comprising:
the first connector according to claim 1, and a counterpart connector which mates with the first connector.

5. A second connector comprising:
(a) a second connector body, and
a second terminal mounted to the second connector body,
(b) the second connector body includes a second recessed groove part and a pair of second side wall parts extending in a longitudinal direction of the second connector body, arranged in parallel demarcating both sides of the second recessed groove part, wherein
(c) a plurality of the second terminals are arranged along each second side wall part forming a pair of parallel terminal group rows,
each terminal group row includes at least a part of a second ground member, and
the second ground member is exposed on the mounting surface of the second connector body and is connected by solder to reference potential wiring positioned to the center as well as to the outside of the second connector body.

6. The second connector according to claim 5, wherein a portion of the second ground member included in each of the terminal group rows is a second ground terminal, and the second ground terminals included in each of the terminal group rows are arranged in a position facing each other and connected via the second ground connecting part.

7. The second connector according to claim 5 or 6, wherein the second connector body includes a second mating guide part formed at both ends in the longitudinal direction thereof and a second reinforcement fitting connected to the second ground member is mounted to this second mating guide part.

8. A connector pair, comprising:
the second connector according to claim 5, and a counterpart connector which mates with the second connector.
